(19) United States
(12) Patent Application Publication
(10) Pub. No.: US 2016/0141903 A1
(43) Pub. Date: May 19, 2016

(54) POWER CHARGER FOR MOBILE DEVICES

(71) Applicant: Superior Communications, Inc., Irwindale, CA (US)

(72) Inventors: George Chen, Chatsworth, CA (US); Samuel Sentosa, Chino, CA (US)

(21) Appl. No.: 14/945,142

(22) Filed: Nov. 18, 2015

Related U.S. Application Data
(60) Provisional application No. 62/082,042, filed on Nov. 19, 2014.

(51) Int. Cl. H02J 7/00

(52) U.S. Cl. CPC H02J 7/0052; H02J 7/0045; H02J 2007/0096; H02J 2007/0062

(57) ABSTRACT

A power charger device. The power charger device may include a body with power prongs extending from the body, power prong receptacles, and a data transfer plug receptacle. A circuit may provide power from the power prongs to the power prong receptacles and the data transfer plug receptacle.

### CROSS REFERENCE TO RELATED APPLICATIONS

The present application claims the benefit of U.S. Provisional Application No. 62/082,042, entitled “POWER CHARGER FOR MOBILE DEVICES,” filed Nov. 19, 2014, the entire disclosure of which is incorporated herein by reference.

### BACKGROUND

Mobile devices typically include an input port that allows the mobile device to transfer data and receive power. The mobile device may transfer data through the input port in a syncing operation with a home device such as a computer or the like. The mobile device may receive power through the input port to charge an internal battery of the mobile device. A data transfer cable, such as a Universal Serial Bus (USB) cable, may be used to transfer data with the home device and also receive power from the home device.

A charger device may be used to provide power to the mobile device in situations where the mobile device is not near the home device. The charger device may plug into the power prong receptacles of a standard wall socket and be configured to provide power to a data transfer cable.

These kinds of charger devices suffer from a series of drawbacks, however, as the charger device prevents a user from using the receptacles of the standard wall socket for other purposes while the charger device is plugged therein. A user may have to choose between powering the mobile device, or using the standard wall socket to power another nearby device. The user may have to repeatedly insert and remove these kinds of charger devices based on the kind of device that should be powered. These kinds of charger device also typically interfere with other power receptacles of the wall socket, and other nearby structures.

### SUMMARY

The embodiments of power charger devices disclosed herein are directed to address the problems existing with prior forms of charger devices. In one embodiment, the power charger device includes power prong receptacles and a data transfer plug receptacle. The power charger device includes a circuit to provide power to both the power prong receptacles and the data transfer plug receptacle. The power charger device reduces the problem of a user having to choose between powering a mobile device or powering another nearby device.

In one embodiment, the power charger device positions the power prong receptacles and a data transfer plug receptacle on faces of the power charger device, to allow for enhanced access to the power prong receptacles and the data transfer plug receptacle. The power charger device is structured compact, to reduce the interference of the charger device with other power receptacles of a power socket, and other nearby structures.

### BRIEF DESCRIPTION OF THE DRAWINGS

Features and advantages of the systems, apparatuses, and methods as disclosed herein will become appreciated as the same become better understood with reference to the specification, claims, and appended drawings wherein:

FIG. 1A illustrates a front view of a power charger device according to an embodiment of the present disclosure.

FIG. 1B illustrates a front perspective view of a power charger device according to the embodiment shown in FIG. 1A.

FIG. 1C illustrates a right side perspective view of a power charger device according to the embodiment shown in FIG. 1A.

FIG. 1D illustrates a bottom side perspective view of a power charger device according to the embodiment shown in FIG. 1A.

FIG. 2 illustrates a front perspective schematic view of a power charger device according to the embodiment shown in FIG. 1A.

FIG. 3 illustrates a rear schematic view of a power charger device according to the embodiment shown in FIG. 1A.

FIG. 4 illustrates a front schematic view of a power charger device according to the embodiment shown in FIG. 1A.

FIG. 5 illustrates a side perspective view of a power charger device according to the embodiment shown in FIG. 1A.

FIGS. 6, 6A, and 6B illustrate an electrical schematic of a power charger device.

FIG. 7A illustrates a front view of a power charger device according to an embodiment of the present disclosure.

FIG. 7B illustrates a front perspective view of a power charger device according to the embodiment shown in FIG. 7A.

FIG. 7C illustrates a right side perspective view of a power charger device according to the embodiment shown in FIG. 7A.

FIG. 7D illustrates a right side perspective view of a power charger device according to the embodiment shown in FIG. 7A.

FIG. 8A illustrates a front view of a power charger device according to an embodiment of the present disclosure.

FIG. 8B illustrates a front perspective view of a power charger device according to the embodiment shown in FIG. 8A.

FIG. 8C illustrates a front perspective view of a power charger device according to the embodiment shown in FIG. 8A.

FIG. 8D illustrates a right side perspective view of a power charger device according to the embodiment shown in FIG. 8A.

FIG. 9A illustrates a front view of a power charger device according to an embodiment of the present disclosure.

FIG. 9B illustrates a front perspective view of a power charger device according to the embodiment shown in FIG. 9A.

FIG. 9C illustrates a rear perspective view of a power charger device according to the embodiment shown in FIG. 9A.

FIG. 10A illustrates a front view of a power charger device according to an embodiment of the present disclosure.

FIG. 10B illustrates a right side perspective view of a power charger device according to the embodiment shown in FIG. 10A.

FIG. 100 illustrates a rear perspective view of a power charger device according to the embodiment shown in FIG. 10A.

FIG. 11A illustrates a front view of a power charger device according to an embodiment of the present disclosure.

FIG. 11B illustrates a right side perspective view of a power charger device according to the embodiment shown in FIG. 11A.

FIG. 11C illustrates a left side perspective view of a power charger device according to the embodiment shown in FIG. 11A.

FIG. 12A illustrates a front view of a power charger device according to an embodiment of the present disclosure.

FIG. 12B illustrates a right side perspective view of a power charger device according to the embodiment shown in FIG. 12A.

FIG. 12C illustrates a left side perspective view of a power charger device according to the embodiment shown in FIG. 12A.

FIG. 12D illustrates a bottom perspective view of a power charger device according to the embodiment shown in FIG. 12A.

FIG. 13A illustrates a front view of a power charger device according to an embodiment of the present disclosure.

FIG. 13B illustrates a front perspective view of a power charger device according to the embodiment shown in FIG. 13A.

FIG. 13C illustrates a right side perspective view of a power charger device according to the embodiment shown in FIG. 13A.

FIG. 14A illustrates a front view of a power charger device according to an embodiment of the present disclosure.

FIG. 14B illustrates a front perspective view of a power charger device according to the embodiment shown in FIG. 14A.

FIG. 14C illustrates a bottom side perspective view of a power charger device according to the embodiment shown in FIG. 14A.

FIG. 14D illustrates a left side perspective view of a power charger device according to the embodiment shown in FIG. 14A.

FIG. 15A illustrates a front view of a power charger device according to an embodiment of the present disclosure.

FIG. 15B illustrates a front perspective view of a power charger device according to the embodiment shown in FIG. 15A.

FIG. 15C illustrates a right side perspective view of a power charger device according to the embodiment shown in FIG. 15A.

FIG. 16A illustrates a front view of a power charger device according to an embodiment of the present disclosure.

FIG. 16B illustrates a front perspective view of a power charger device according to the embodiment shown in FIG. 16A.

FIG. 16C illustrates a right side perspective view of a power charger device according to the embodiment shown in FIG. 16A.

FIG. 17A illustrates a front view of a power charger device according to an embodiment of the present disclosure.

FIG. 17B illustrates a front perspective view of a power charger device according to the embodiment shown in FIG. 17A.

FIG. 17C illustrates a left side perspective view of a power charger device according to the embodiment shown in FIG. 17A.

FIG. 17D illustrates a rear perspective view of a power charger device according to the embodiment shown in FIG. 17A.

FIG. 18A illustrates a front view of a power charger device according to an embodiment of the present disclosure.

FIG. 18B illustrates a front perspective view of a power charger device according to the embodiment shown in FIG. 18A.

FIG. 18C illustrates a left side perspective view of a power charger device according to the embodiment shown in FIG. 18A.

FIG. 18D illustrates a rear perspective view of a power charger device according to the embodiment shown in FIG. 18A.

FIG. 19A illustrates a front view of a power charger device according to an embodiment of the present disclosure.

FIG. 19B illustrates a front perspective view of a power charger device according to the embodiment shown in FIG. 19A.

FIG. 19C illustrates a rear perspective view of a power charger device according to the embodiment shown in FIG. 19A.

FIG. 20A illustrates a front view of a power charger device according to an embodiment of the present disclosure.

FIG. 20B illustrates a front perspective view of a power charger device according to the embodiment shown in FIG. 20A.

FIG. 20C illustrates a left side perspective view of a power charger device according to the embodiment shown in FIG. 20A.

FIG. 21A illustrates a front view of a power charger device according to an embodiment of the present disclosure.

FIG. 21B illustrates a front perspective view of a power charger device according to the embodiment shown in FIG. 21A.

FIG. 21C illustrates a bottom side perspective view of a power charger device according to the embodiment shown in FIG. 21A.

### DETAILED DESCRIPTION

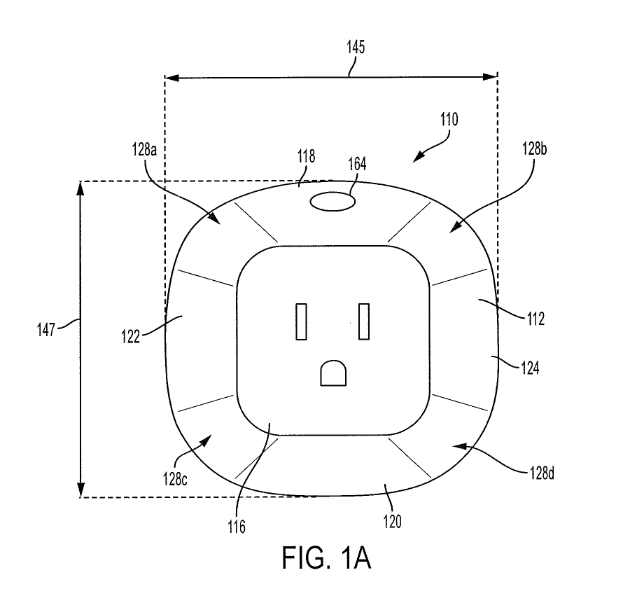

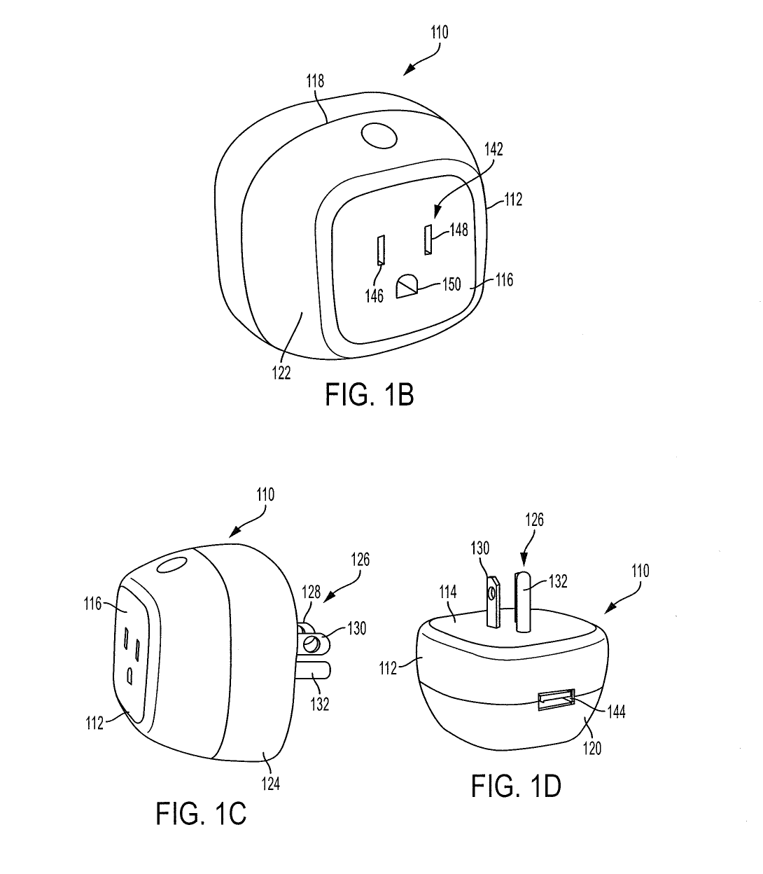

FIGS. 1A-1D illustrate an embodiment of a power charger device 110. The power charger device includes a charger body 112. The charger body 112 may include a rear face 114 (shown in FIG. 1D), a front face 116, and side faces 118, 120, 122, 124. The side faces may include a top face 118, a bottom face 120, a left face 122, and a right face 124. The front face 116 may face opposite the rear face 114, the top face 118 may face opposite the bottom face 120, and the left face 122 may face opposite the right face 124.

The faces may be identified according to their relative positions if a power prong set 126 were inserted into a standard vertically oriented wall socket, with the grounding receptacle positioned downward of the live and neutral receptacles if applicable. The front face 116 may face out from the front of the charger body 112 when the power prong set 126 is inserted into a wall socket. The rear face 114 may face out from the rear of the charger body 112 when the power prong set 126 is inserted into a wall socket. The side faces 118, 120, 122, 124 may face out from the sides of the charger body 112 when the power prong set 126 is inserted into a wall socket. The top face 118, bottom face 120, left face 122, and right face 124 may face out from the respective top, bottom, left, and right sides of the charger body 112 when the power prong set 126 is inserted into a wall socket. The terms top face 118 and bottom face 120, and the terms left side 122 and right side 124 may be interchangeable in an embodiment in which the power prong set 126 may be rotated 180 degrees and still be effectively plugged into a power socket, for example if the power prong set 126 does not include a grounding prong. The designations of top, bottom, left, and right remain if the power charger device 110 were inserted downward into a power socket of a power strip for example.

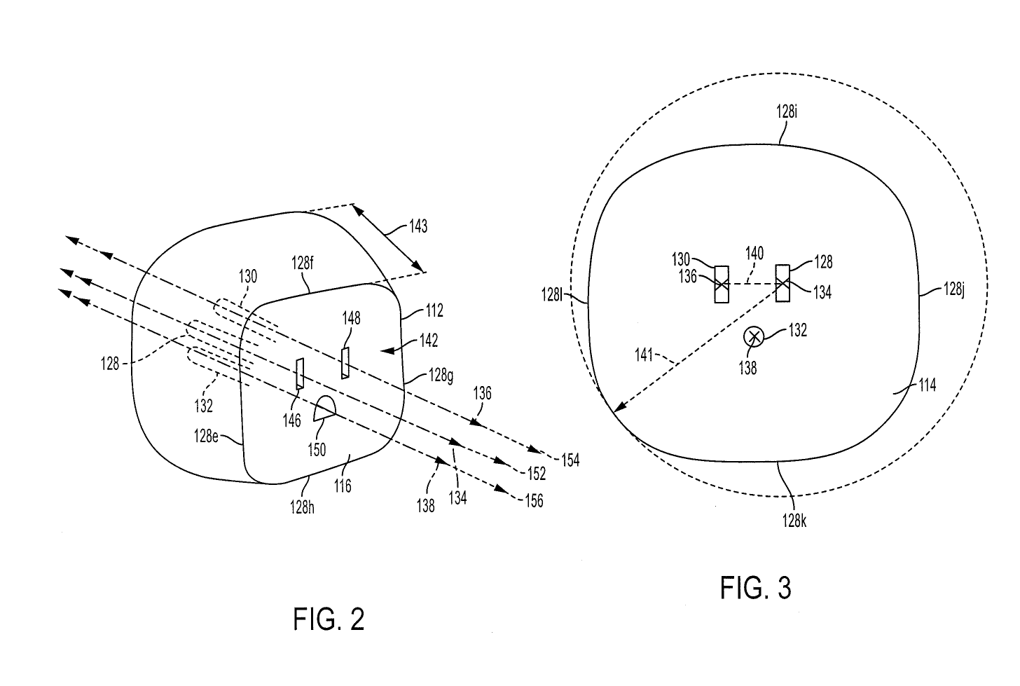

The side faces 118, 120, 122, 124 may join the rear face 114 to the front face 116. Edges 128a-d on the side of the body 112 may join the side faces 118, 120, 122, 124 to each other. Edges 128e-h (marked in FIG. 2) on the front of the body 112 may join the front face 116 to the side faces 118, 120, 122, 124. Edges 1281-1 (marked in FIG. 3) on the rear of the body 112 may join the rear face 114 to the side faces 118, 120, 122, 124. In one embodiment, the transition between faces of the body 112 may not be defined, for example, in an embodiment in which the body has a cylindrical shape, an edge may not define the transition between the side faces of the cylindrical body.

The side faces 118, 120, 122, 124 may extend between the rear face 114 and the front face 116 to define the volume of the body 112.

The front face 116 as shown in FIGS. 1A-1C is substantially flat. The rear face 114 as shown in FIG. 1D is substantially flat. The side faces 118, 120, 122, 124 as shown in FIGS. 1A-1D are curved. In other embodiments, any of the faces 114, 116, 118, 120, 122, 124 may be substantially flat or have any contour or curvature as desired.

The body 112 has a shape and size that is preferably compact to reduce the overall profile of the power charger device 110. The body 112 may have a shape and size to allow the power charger device 110 to plug into a power socket without the power charger device 110 interfering with other nearby power sockets on a wall or power strip or the like. The body 112 as shown in FIGS. 1A-1D has a substantially cuboid shape. In one embodiment, the body 112 may have a substantially cube shape. The body 112 may serve as a housing to contain elements within the body 112. The body 112 is preferably portable, and sized to fit in the palm of a user's hand.

The body 112 may have a size that is defined relative to proportions of a power prong set 126. In one embodiment, the body 112 may have a size that is defined to operate in accordance with standard size set for power prongs 126 and power sockets, for example a National Electrical Manufacturers Association (NEMA) standard as used in North America, among other standards.

Referring to FIG. 2, each of the prongs 128, 130, 132 of the power prong set 126 may extend on a respective axis 134, 136, 138. Referring to FIG. 3, the axes 134, 136, 138 that the prongs 128, 130, 132 extend on passes through a centerline of the respective prong 128, 130, 132. The centerline is the line passing through the centroid of the prong. The prongs 128, 130 may have a distance 140 between their respective centerlines. In one embodiment, the prongs 128, 130 may have a distance 140 of no more than about 1.3 centimeters. In one embodiment, the prongs 128, 130 may have a distance 140 of between about 1.2 centimeters and 1.4 centimeters. In one embodiment, a different distance 140 may be used as desired.

The cross section of the body 112 in a plane perpendicular to one of the axes 134, 136, 138 may have its greatest extent as a function of the distance 140 between the centerlines of the prongs 128, 130. The cross section of the body 112 may have its greatest radial distance 141 from the prong 128 for example of no more than about 1.5 times the centerline distance of prong 128 from prong 130. In one embodiment, the cross section of the body 112 may have its greatest radial distance 141 from the prong 128 for example of no more than about 1.8 times the centerline distance of prong 128 from prong 130. In one embodiment, the cross section of the body 112 may have its greatest radial distance 141 from the prong 128 for example of no more than about 2.5 times the centerline distance of prong 128 from prong 130. In one embodiment, the cross section of the body 112 may have its greatest radial distance 141 from the prong 128 for example of no more than about 3 times the centerline distance of prong 128 from prong 130. In one embodiment, the cross section of the body 112 may have its greatest radial distance 141 from the prong 128 for example of no more than about 3.5 times the centerline distance of prong 128 from prong 130. These dimensions may reduce the interference of the body 112 with other power sockets that may be located nearby. In other embodiments, other greatest radial distances 141 may be utilized.

In one embodiment, the body 112 may have its cross section in a plane perpendicular to one of the axes 134, 136, 138 be at its greatest size at a size of no more than about 6.5 square centimeters. In one embodiment, the body 112 may have its greatest cross section in a plane perpendicular to one of the axes 134, 136, 138 be no more than about 8 square centimeters. In one embodiment, the body 112 may have its greatest cross section in a plane perpendicular to one of the axes 134, 136, 138 be no more than about 10 square centimeters. In one embodiment, the body 112 may have its greatest cross section in a plane perpendicular to one of the axes 134, 136, 138 be no more than about 15 square centimeters. In one embodiment, the body 112 may have its greatest cross section in a plane perpendicular to one of the axes 134, 136, 138 be no more than about 20 square centimeters. In one embodiment, the body 112 may have its greatest cross section in a plane perpendicular to one of the axes 134, 136, 138 be no more than about 45 square centimeters. In these embodiments, the size of the body 112 may be tailored for the NEMA standard as used in North America. In other embodiments, a different greatest cross section may be utilized.

The body 112 may have a greatest length 143, width 145, and height 147. In one embodiment, the length 143 may be set to no more than about 3 cm; in one embodiment, the length 143 may be set to no more than about 3.5 cm; and in one embodiment, the length 143 may be set to no more than about 4 cm. The length of the body 112 may be set to reduce the total profile of the body 112 in a direction along the axes 134, 136, 138 of the power prong set 126. The length of the body 112 may also be sized to allow a user to easily grip and insert or remove the power charger device 110 from a power socket. The dimensions may be set in accordance with the NEMA standard as used in North America.

In one embodiment, the width 145 may be set to no more than about 2.8 cm; in one embodiment, the width 145 may be set to no more than about 3 cm; in one embodiment, the width 145 may be set to no more than about 3.5 cm; in one embodiment, the width 145 may be set to no more than about 4 cm; in one embodiment, the width 145 may be set to no more than about 4.5 cm; in one embodiment, the width 145 may be set to no more than about 5.5 cm; and in one embodiment, the width 145 may be set to no more than about 6.5 cm. In one embodiment, the height 147 may be set to no more than about 2.8 cm; in one embodiment, the height 147 may be set to no more than about 3 cm; in one embodiment, the height 147 may be set to no more than about 3.5 cm; in one embodiment, the height 147 may be set to no more than about 4 cm; in one embodiment, the height 147 may be set to no more than about 4.5 cm; in one embodiment, the width 145 may be set to no more than about 5.5 cm; and in one embodiment, the height 147 may be set to no more than about 6.5 cm. In other embodiments, other greatest lengths 143, widths 145, and heights 147 may be utilized.

In one embodiment, the body 112 may have a total volume of no more than about 19 cubic centimeters; in one embodiment, the body 112 may have a total volume of no more than about 24 cubic centimeters; in one embodiment, the body 112 may have a total volume of no more than about 32 cubic centimeters; in one embodiment, the body 112 may have a total volume of no more than about 43 cubic centimeters; in one embodiment, the body 112 may have a total volume of no more than about 56 cubic centimeters; and in one embodiment, the body 112 may have a total volume of no more than about 81 cubic centimeters. In one embodiment, the body 112 may have a total volume that is a multiple of any combination of the greatest lengths 143, widths 145, and heights 147 disclosed in this application. In one embodiment, another total volume for the body 112 may be utilized. The total volume may be configured to allow for access to the receptacles of the body 112, yet provide a compact size to reduce interference with nearby structures of the power socket.

The prongs 128, 130, 132 may extend outward from the rear face 114 of the charger body 112. The prongs 128, 130, 132 may be configured as blade or pin prongs, or other forms of prongs used to insert into power prong receptacles of a power socket. The prongs 128, 130, 132 may be configured according to the wiring of the power socket to which the prongs 128, 130, 132 will be inserted. The prong 132 may be configured as a grounding prong, and may have a pin shape. The prongs 128, 130 may be configured as blade shaped prongs. The prong 128 may be configured to be inserted into a neutral receptacle of a power socket, and accordingly serves as a neutral prong. The prong 130 may be configured to be inserted into a live receptacle of a power socket, and accordingly serves as a live prong. In one embodiment, the grounding prong 132 may be excluded. In one embodiment, the configuration of the prongs of the power prong set 126 may be varied as desired.

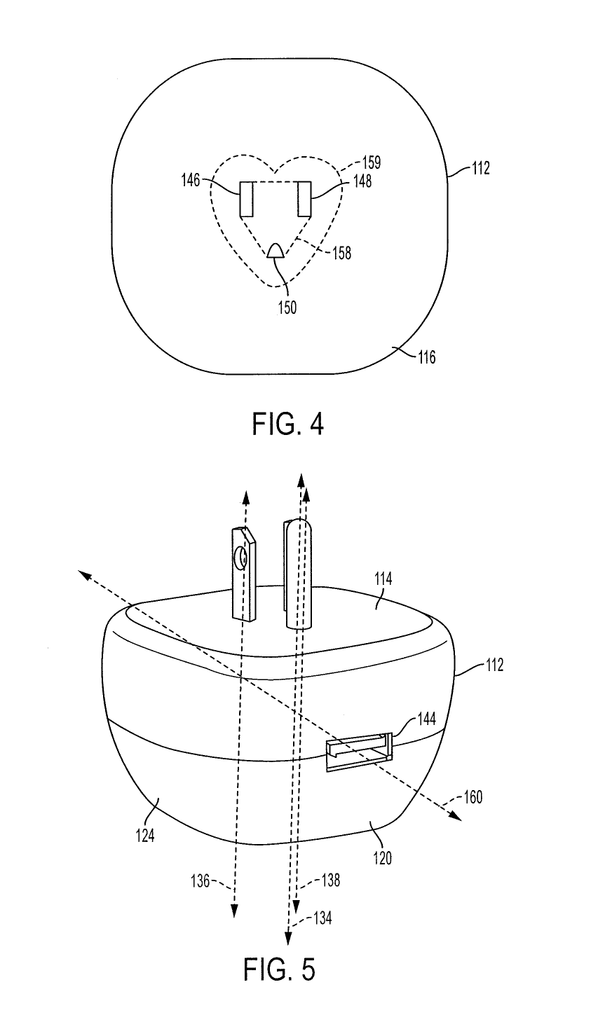

The power charger device 110 may include a power prong receptacle set 142 and a data transfer plug receptacle 144. The power prong receptacle set 142 is preferably positioned to increase the accessibility of the power prong receptacles 146, 148, 150 for a user to plug power prongs into the power prong receptacles 146, 148, 150. The power prong receptacles 146, 148, 150 include openings in the outer surface of the body 112 that allow a user to plug power prongs into the power prong receptacles 146, 148, 150, and include electrical terminals that allow power to be transferred to power prongs inserted into the receptacles 146, 148, 150. The power prong receptacles 146, 148, 150 may be positioned on a front face 116 of the body 112 and/or any of the side faces 118, 120, 122, 124 of the body 112. The power prong receptacles 146, 148, 150 may extend on axes 152, 154, 156 as shown in FIG. 2 for example. Any of the axes 152, 154, 156 may extend substantially parallel to the axes 134, 136, 138 that the prongs 128, 130, 132 extend on. In one embodiment, as shown in FIG. 2, any of the power prong receptacles 146, 148, 150 may extend on substantially the same axes that the power prongs 128, 130, 132 extend on. Any of the axes 134, 136, 138 may pass through the respective openings of the power prong receptacles 146, 148, 150. In one embodiment, any of the axes 152, 154, 156 may be offset from the axes 134, 136, 138. In one embodiment, any of the axes 134, 136, 138 may pass through power prong receptacles 146, 148, 150, and/or an area 158 (shown in FIG. 4 for example) in between the power prong receptacles 146, 148, 150, and/or an area 159 (shown in FIG. 4 for example) extending outward from any of the power prong receptacles 146, 148, 150 no more than about 45% of the distance between the power prong receptacles 146, 148. In one embodiment, any of the axes 134, 136, 138 may pass through an area 159 extending outward from any of the power prong receptacles 146, 148, 150 no more than about 60% of the distance between the power prong receptacles 146, 148.

The relative position of the power prongs 128, 130, 132 and the power prong receptacles 146, 148, 150 may enhance the compact structure of the charger body 112 and reduce the interference of the power charger device 110 with nearby power sockets. The power prong receptacle set 142 may be positioned on the front face 116 of the body 112 to allow power prongs to be inserted into the power prong receptacle set 142 in a similar orientation as if though the power charger device 110 were not present and the power prongs would be inserted into a wall socket for example.

In one embodiment, the power prong receptacles 146, 148, 150 may be positioned on respective axes that extend transverse to the axes of any of the power prongs 128, 130, 132. The power prong receptacles 146, 148, 150 may be positioned on a side face 118, 120, 122, 124 of the body 112. In one embodiment, the power prong receptacles 146, 148, 150 may be positioned on a combination of a front face 116 and any of the side faces 118, 120, 122, 124. In one embodiment, the power prong receptacles 146, 148, 150 may be positioned on respective axes that extend substantially perpendicular to the axes of any of the power prongs 128, 130, 132.

The power prong receptacles 146, 148, 150 may be configured to receive certain types of power prongs. For example, the receptacle 150 may be configured to receive a grounding prong. The receptacle 146 may be configured to receive a neutral prong. The receptacle 148 may be configured to receive a live prong. The structures of the receptacles 146, 148 may be similar, of may be different, for example in an embodiment in which the receptacles 146, 148 are configured to receive polarized power prongs.

The data transfer plug receptacle 144 is preferably positioned to increase the accessibility and use of both the power prong receptacles 146, 148, 150 and the data transfer plug receptacle 144 simultaneously, while maintaining a compact size for the power charger device 110. The data transfer plug receptacle 144 includes an opening in the outer surface of the body 112 that allows a user to plug a data transfer plug into the data transfer plug receptacle 144. The data transfer plug receptacle 144 is preferably positioned on any of the side faces 118, 120, 122, 124 of the body 112. Referring to FIG. 5, the data transfer plug receptacle 144 may extend on an axis 160. The axis 160 may extend transverse to the axes of any of the power prongs 128, 130, 132 and/or any of the power prong receptacles 146, 148, 150. In one embodiment, the axis 160 may extend substantially perpendicular to the axes of any of the power prongs 128, 130, 132 and/or any of the power prong receptacles 146, 148, 150. In one embodiment, the data transfer plug receptacle 144 may be preferably positioned on a face of the body 112 that the power prong receptacles 146, 148, 150 are not positioned on.

In one embodiment, the data transfer plug receptacle 144 may extend on an axis that is substantially parallel or substantially similar to any of the axes 134, 136, 138 that the prongs 128, 130, 132 extend on and/or any of the axes 152, 154, 156 the power prong receptacles 146, 148, 150 extend on. In one embodiment, the data transfer plug receptacle 144 may be positioned on the front face 116 of the body 112. In one embodiment, the data transfer plug receptacle 144 may be positioned on the same face of the body 112 as the prong receptacles 146, 148, 150. In one embodiment, the data transfer plug receptacle 144 may be positioned on a combination of a front face 116 and any of the side faces 118, 120, 122, 124.

The data transfer plug receptacle 144 is configured to deliver electrical power to a data transfer plug inserted therein. The data transfer plugs are configured to transfer power, preferably to a mobile device, for example, a mobile phone, a tablet, a portable music player, a personal digital assistant, combinations thereof, or other forms of mobile devices. The data transfer plugs may also be configured to transfer data, in a configuration in which the mobile device is in engaging in a syncing process, or the like. Such data transfer plugs may include a Universal Serial Bus (USB) data transfer plug, or other serial plug, among others.

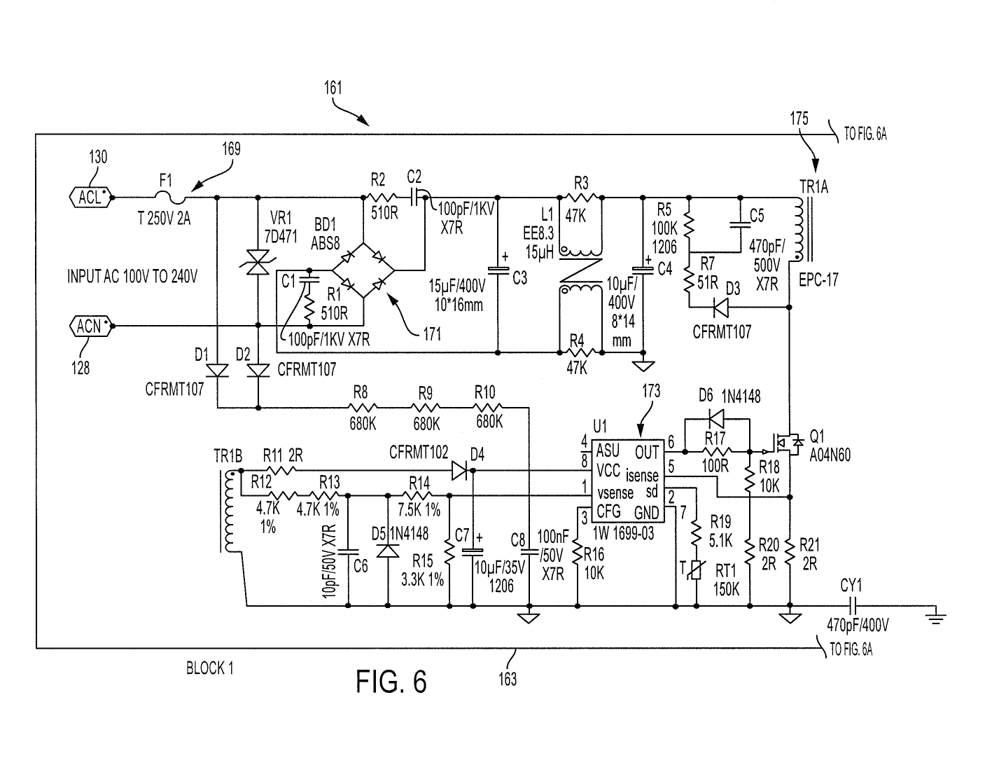

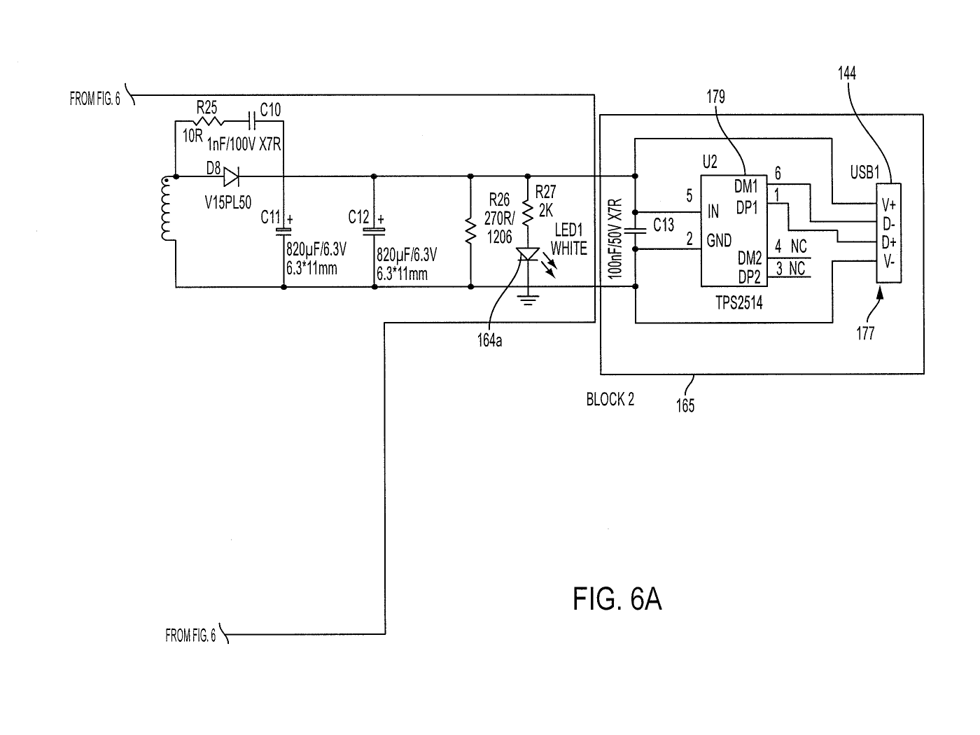

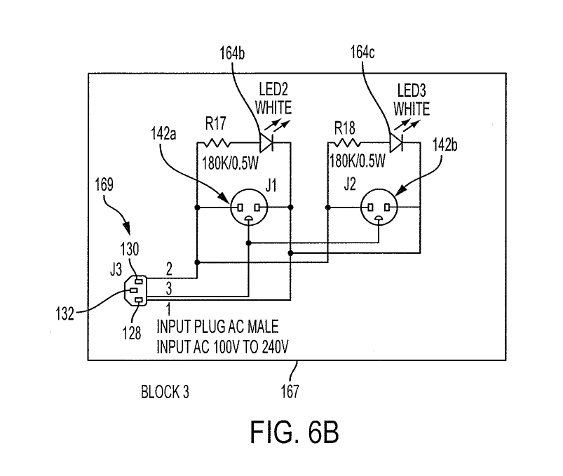

Referring to FIGS. 6, 6A, and 6B, the power charger device 110 may include a circuit 161 positioned within the body 112 configured to provide power from the power prongs 128, 130, 132 to the power prong receptacles 146, 148, 150 and the data transfer plug receptacle 144. The circuit 161 may include an AC/DC converter circuit 163, a DC output circuit 165, and an AC output circuit 167.

The AC/DC converter circuit 163 may include a power input 169, which may comprise the power prongs 128, 130. The circuit 163 may also include a rectifier 171, to convert the AC voltage that is input from a power socket to a DC voltage. The circuit 163 may include a power controller circuit 173 to control the amount of power that is provided from the AC/DC converter circuit 163. In one embodiment, the power controller circuit 173 may be an integrated circuit, and in one embodiment may be a pulse-width modulation control circuit. The circuit 163 may include a transformer 175 to vary the voltage and/or current level provided from the AC/DC converter circuit 163. The AC/DC converter circuit 163 is electrically coupled to the DC output circuit 165, and provides a DC output to the DC output circuit 165.

The DC output circuit 165 may include a power output 177, which may comprise the data transfer plug receptacle 144. In one embodiment, the power output may be between 5 watts and 100 watts. In one embodiment, the power output may be lesser or greater as desired. The circuit 165 may include a charge rate detection circuit 179, which may be an integrated circuit. The charge rate detection circuit 179 may be configured to automatically detect an amount of current that a mobile device will accept to be charged. The amount of current may be a maximum amount of current the mobile device will accept to be charged. In one embodiment, the circuit 179 may be configured to detect the amount of current based on a voltage amount detected on terminals of the data transfer plug. The terminals may be data terminals of the data transfer plug. For example, in an embodiment in which the data transfer plug is a USB plug, voltage on the D+ and/or D− terminals may be used to detect the amount of current that a mobile device will accept to be charged. The DC output circuit 165 may beneficially be able to detect a current that a mobile device will accept to be charged, and provide that amount of current to a variety of different mobile devices. The DC output circuit 165 may be able to detect and provide a maximum amount of current and voltage a mobile device will accept, for a variety of different mobile devices.

In an embodiment in which multiple data transfer plug receptacles 144 are utilized, the DC output circuit 165 may be configured to provide power to each receptacle 144. The DC output circuit 165 may provide power to each receptacle in parallel. The charge rate detection circuit 179 may be configured to detect an amount of current that mobile devices coupled to each receptacle 144 will accept to be charged, for example pins 3 and 4 of the circuit 179 may be used for an additional receptacle 144 in a similar manner as pins 1 and 6.

The AC output circuit 167 may include the power input 169, which may be the same power input 169 as utilized in the AC/DC converter circuit 163. The power input 169 may comprise the power prongs 128, 130, 132. The power prongs 128, 130, 132 may be coupled to the respective receptacles of a power prong receptacle set 142. The AC output circuit 167 may include a surge protector circuit to protect against surges of power delivered to the power prong receptacle set 142. In one embodiment, the DC output circuit 165 may include a surge protector circuit. In one embodiment, the surge protector circuit may be used for both the AC output circuit 167 and the DC output circuit 165.

The AC output circuit 167 may be configured to provide direct power transfer from the power input 169 to the power prong receptacle set 142. The AC output circuit 167 may deliver power to the power prong receptacle set 142 in parallel with the power delivered to the data transfer plug receptacle 144. The AC output circuit 167 may serve as an AC pass through circuit to allow AC power from a power socket to pass through to the power prong receptacle set 142. In an embodiment in which multiple power prong receptacle sets 142a, 142b are utilized, the AC output circuit 167 may deliver power to each receptacle set 142a, 142b in parallel. A letter placed after identical reference numbers in this application indicates the lettered items are different structures yet have the same properties as correspond with the reference number, unless stated otherwise.

The power charger device 110 may be configured to provide power to the receptacles of the power prong receptacle set 142 and to the data transfer plug receptacle 144 simultaneously.

The power charger device 110 may include a power indicator 164. In one embodiment, the power indicator 164 is in the form of a light, which may be an LED or other form of light. The power indicator 164 may be positioned on the body 112. The power indicator 164 may be configured to indicate when the power charger device 110 is plugged into a power socket. In the circuit diagram shown in FIGS. 6, 6A, and 6B, multiple power indicators 164a, 164b, 164c may be utilized to display that power is available for output to the respective data transfer plug receptacle 144 and the power prong receptacle sets 142a, 142b.

In one embodiment, the power indicator 164 may be configured to indicate when power prongs are inserted into the power charger device 110. In one embodiment, the power charger device 110 may include a current draw detection circuit that may detect the draw of current from the data transfer plug receptacle 144. The current draw may be by a mobile device connected to an opposite end of a data transfer cord. The power indicator 164 may be configured to indicate when current is drawn from the data transfer plug receptacle 144, and accordingly that the mobile device is being charged, or the like. The power indicator 164 may be configured to indicate power draw by illuminating. In one embodiment, the power indicator 164 may be configured to indicate a charging status of the mobile device. The power indicator 164 may be configured to display a charge level of the mobile device through different levels of illumination, or different lights, or colors of lights, of the power indicator 164 being illuminated. In one embodiment, the power indicator 164 may display a graphical indicator or a numerical indicator of the charge status of the mobile device. The particular components, including electrical components in the circuit 161 are exemplary, and may be varied in other embodiments.

Additional power prong receptacles 146, 148, 150, and/or data transfer plug receptacles 144 may be positioned on the body 112 than shown in FIGS. 1A-1D. The circuit of the power charger device 110 may be configured to provide power to any additional power prong receptacles 146, 148, 150 or data transfer plug receptacles 144. FIGS. 1A-1D illustrate an embodiment in which the power prong receptacles 146, 148, 150 are positioned on the front face 116 of the body 112. The data transfer plug receptacle 144 is positioned on the bottom face 120 of the body 112. Elements shown and described in this application having similar last two numbers of reference numbers are similar elements, and the description of such elements is applicable to all of these elements unless otherwise stated.

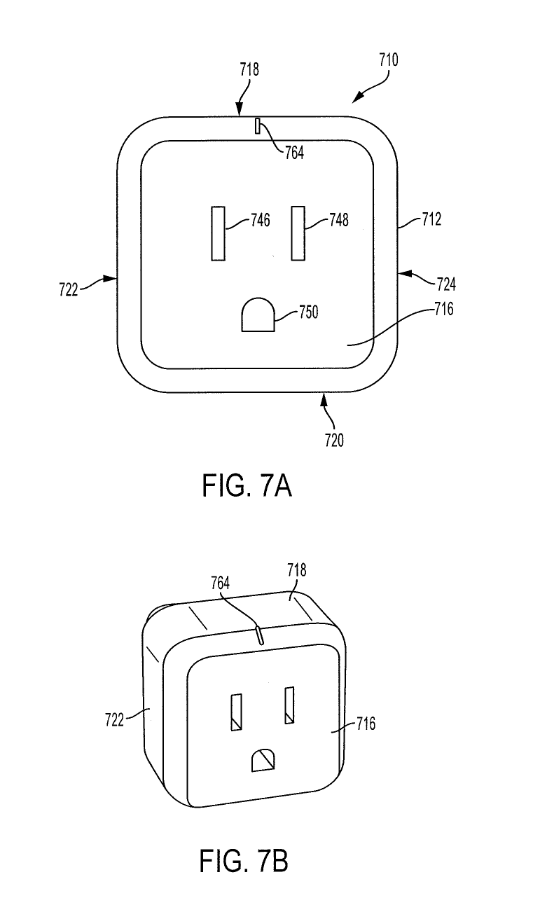

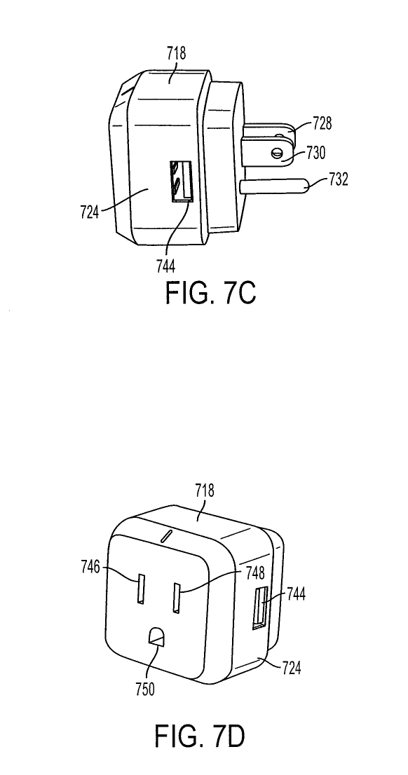

FIGS. 7A-7D illustrate an embodiment of a power charger device 710. The body 712 has a substantially cuboid shape. The side faces 718, 720, 722, 724 are contoured to allow a user to more easily grip the body 712.

The power prong receptacles 746, 748, 750 are positioned on the front face 716 of the body 712. The power prong receptacles 746, 748, 750 extend on axes that are substantially parallel to the axes that the prongs 728, 730, 732 extend on.

The data transfer plug receptacle 744 is positioned on the right side face 724 of the body 712. The data transfer plug receptacle 744 extends on an axis transverse, substantially perpendicular to the axes of the power prongs 728, 730, 732 and the power prong receptacles 746, 748, 750. The power indicator 764 is positioned at an edge of the body 712.

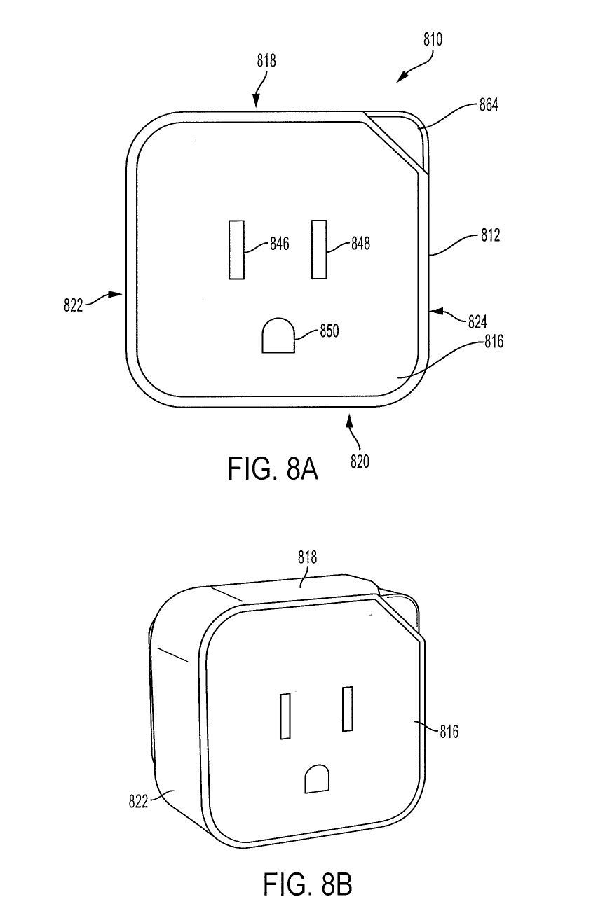

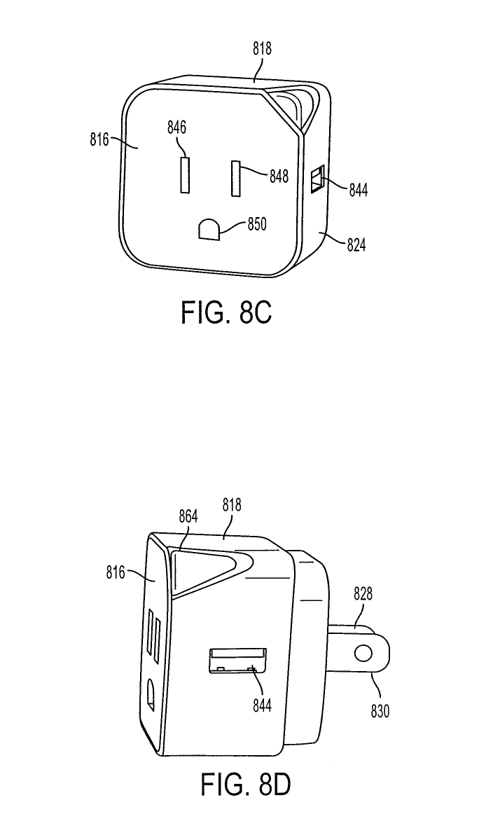

FIGS. 8A-8D illustrate an embodiment of a power charger device 810. The body 812 has a substantially cuboid shape. The side faces 818, 820, 822, 824 are contoured to allow a user to more easily grip the body 812.

The power prong receptacles 846, 848, 850 are positioned on the front face 816 of the body 812. The power prong receptacles 846, 848, 850 extend on axes that are substantially parallel to the axes that the prongs 828, 830 extend on.

The data transfer plug receptacle 844 is positioned on the right side face 824 of the body 812. The data transfer plug receptacle 844 extends on an axis transverse, substantially perpendicular to the axes of the power prongs 828, 830 and the power prong receptacles 846, 848, 850.

The power indicator 864 is positioned on a corner of the body 812.

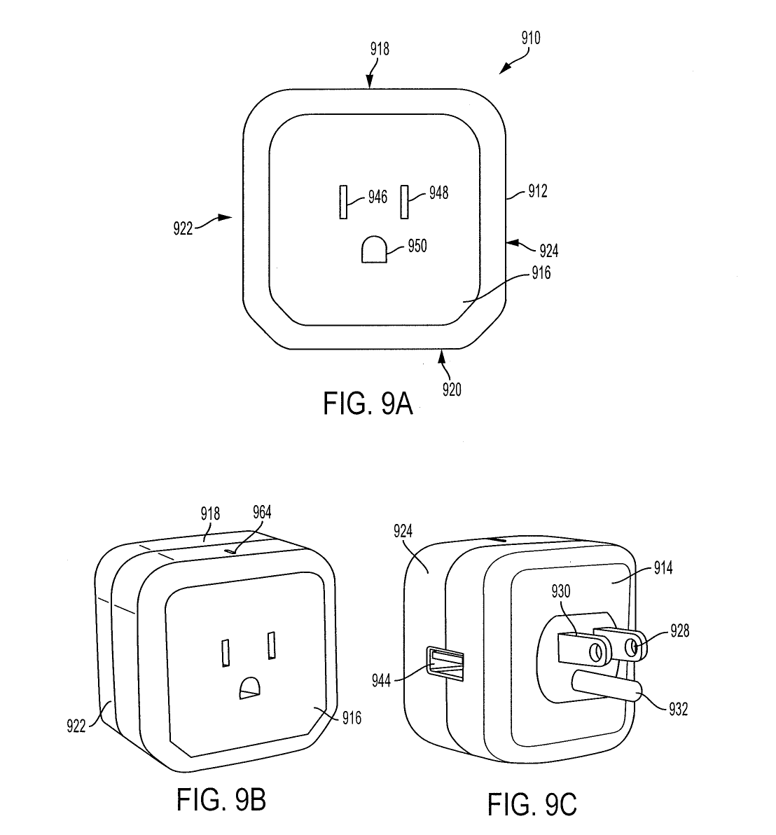

FIGS. 9A-9C illustrate an embodiment of a power charger device 910. The body 912 has a substantially cuboid shape. The side faces 918, 920, 922, 924 are contoured to allow a user to more easily grip the body 912.

The power prong receptacles 946, 948, 950 are positioned on the front face 916 of the body 912. The power prong receptacles 946, 948, 950 extend on axes that are substantially parallel to the axes that the prongs 928, 930, 932 extend on.

The data transfer plug receptacle 944 is positioned on the right side face 924 of the body 912. The data transfer plug receptacle 944 extends on an axis transverse, substantially perpendicular to the axes of the power prongs 928, 930, 932 and the power prong receptacles 946, 948, 950. The power indicator 964 is positioned on a side face 918 of the body 912.

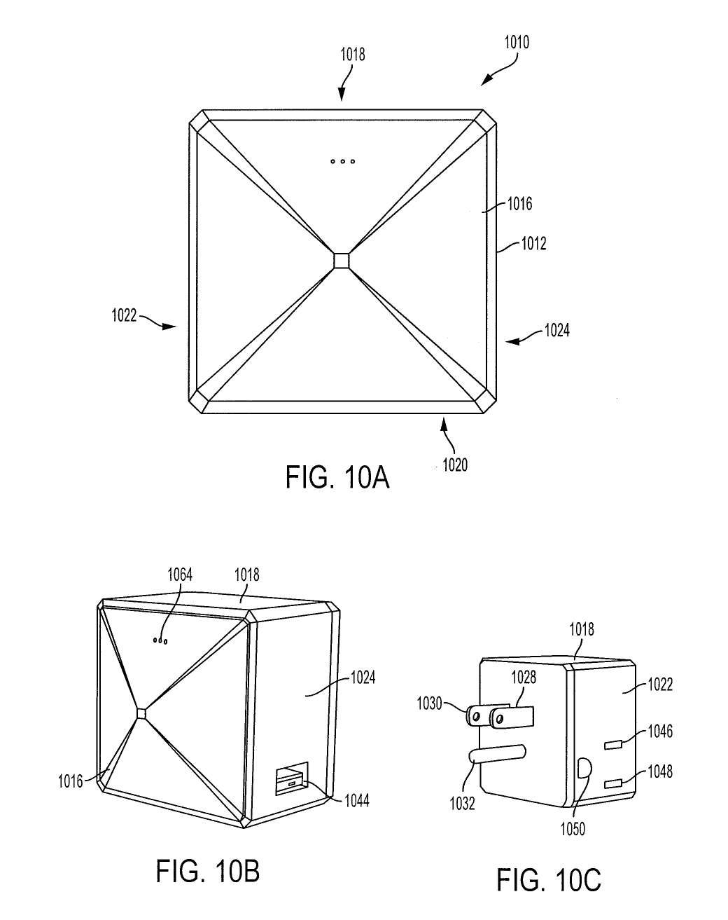

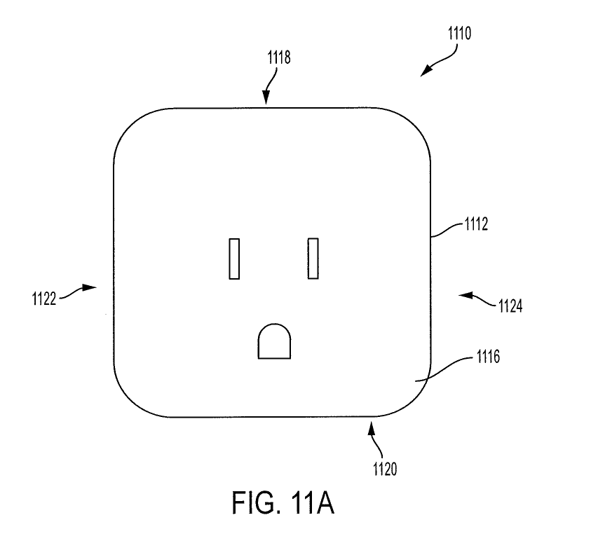

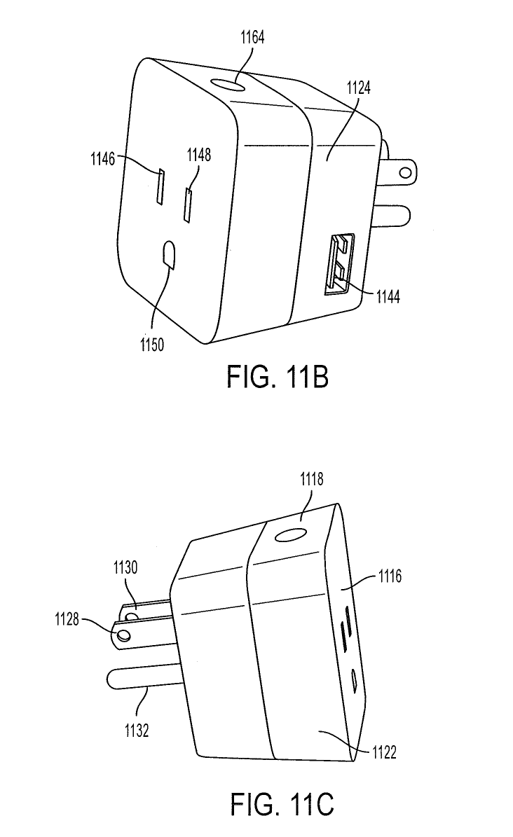

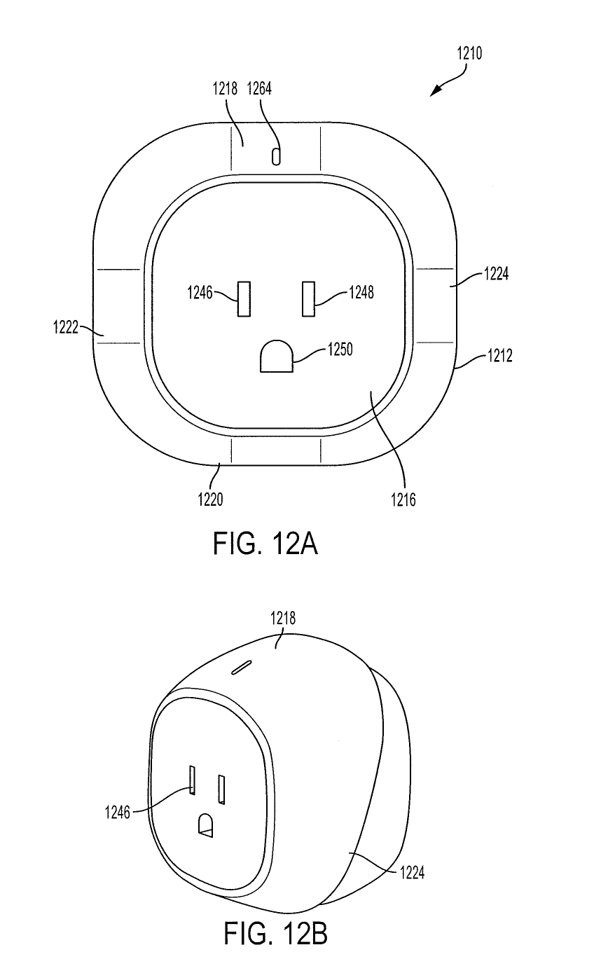

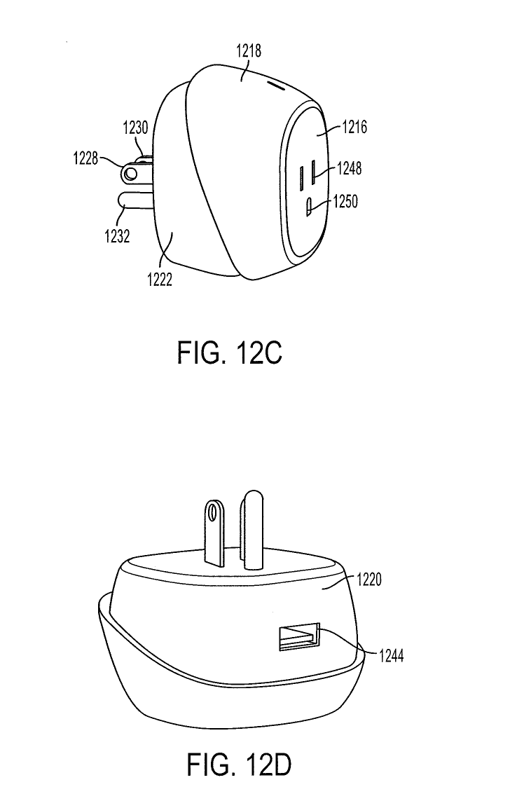

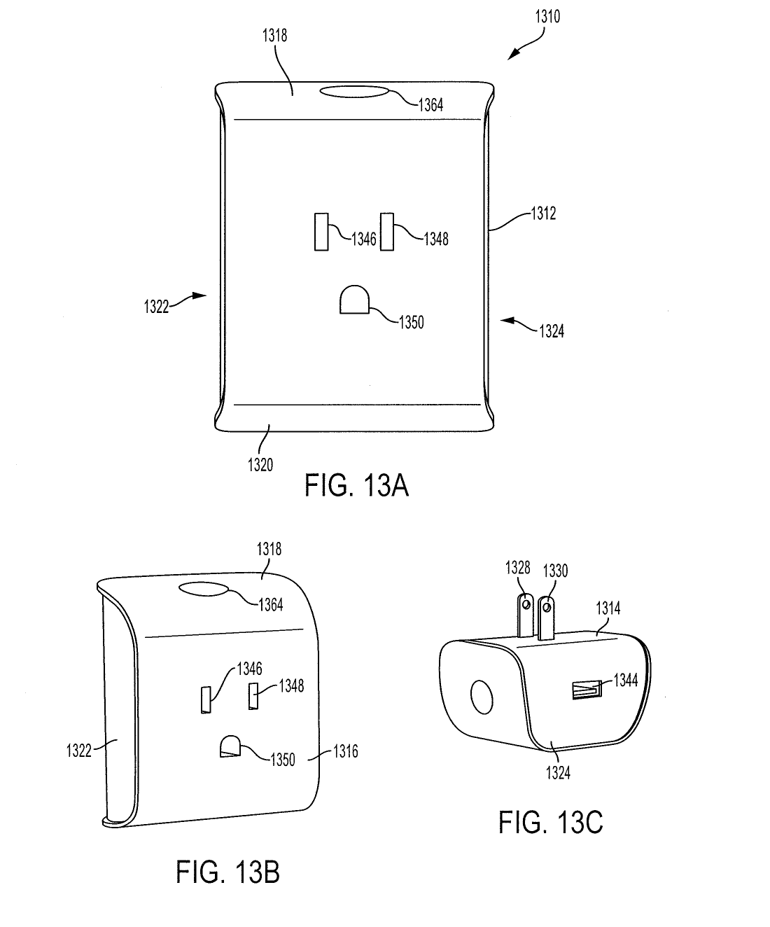

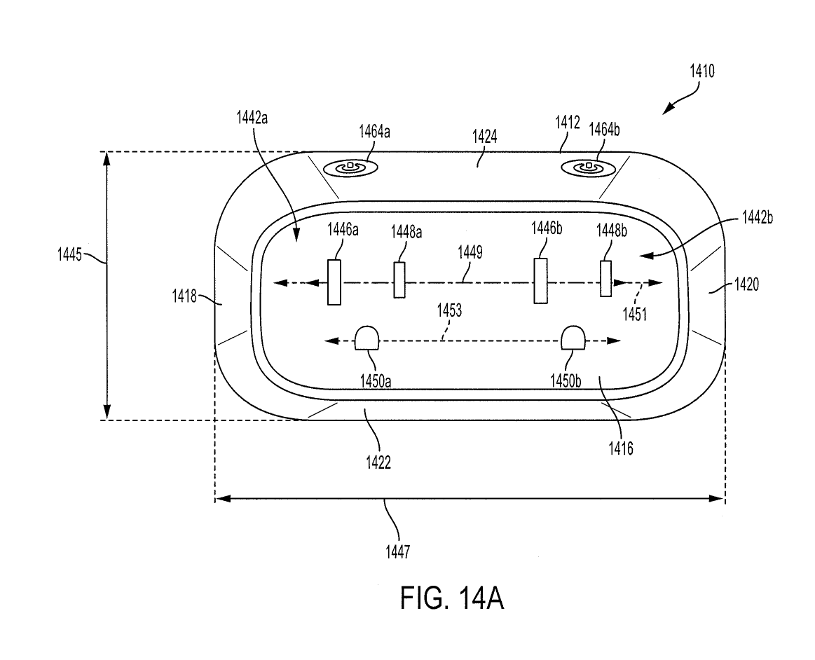

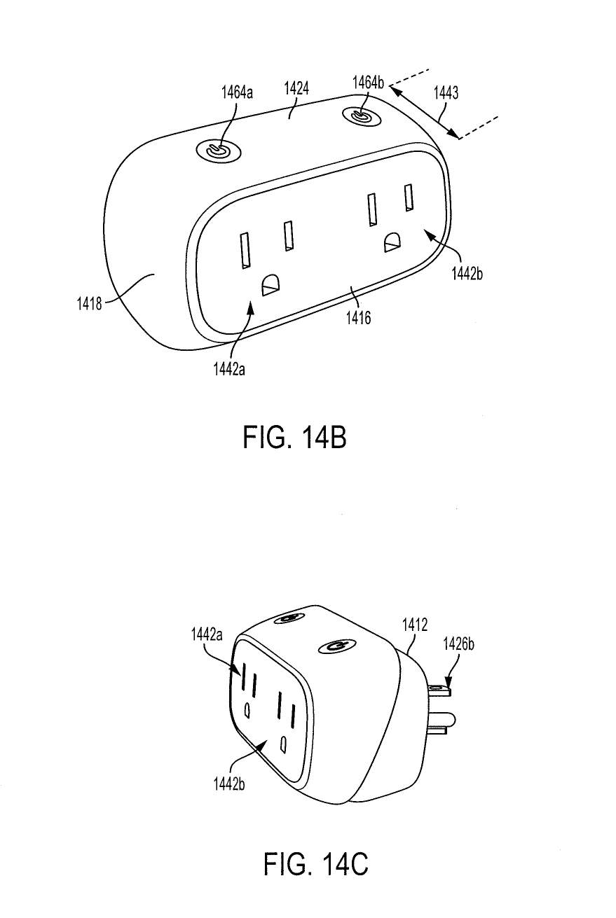

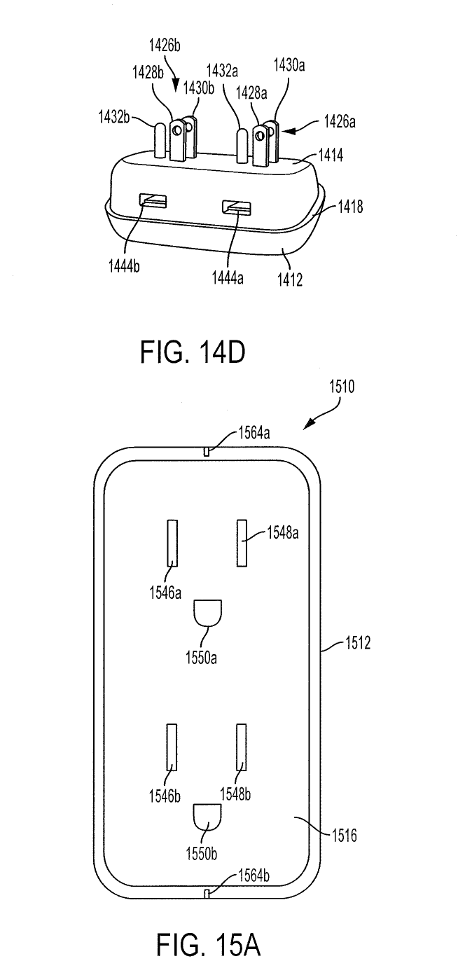

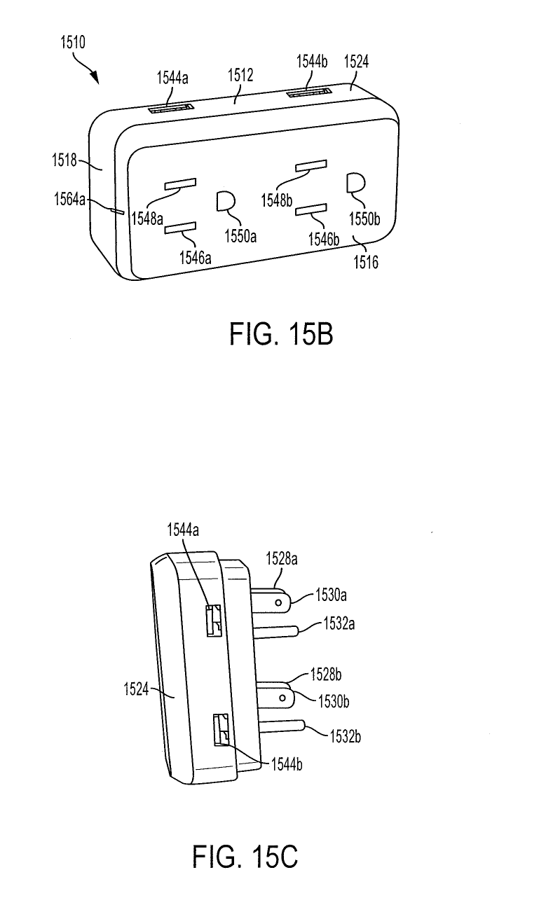

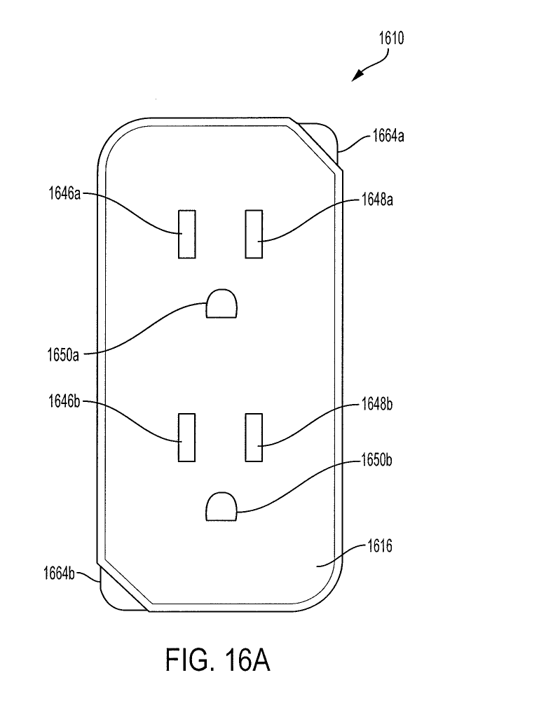

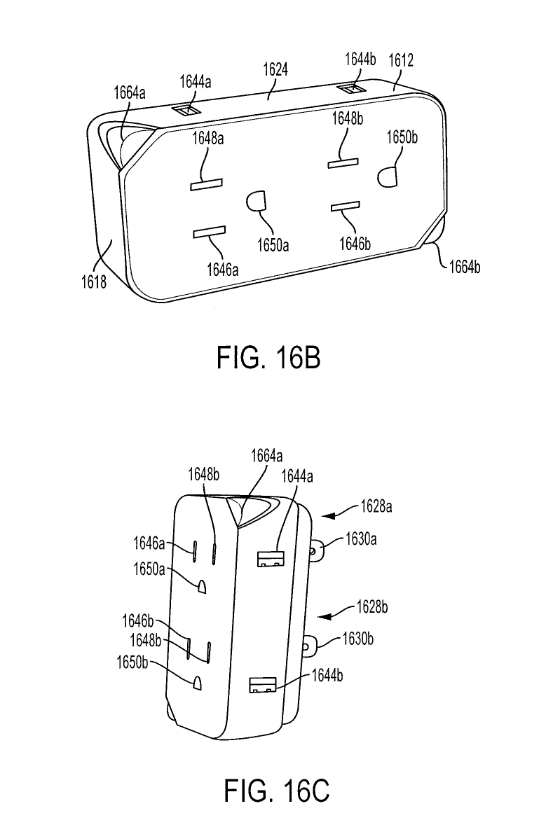

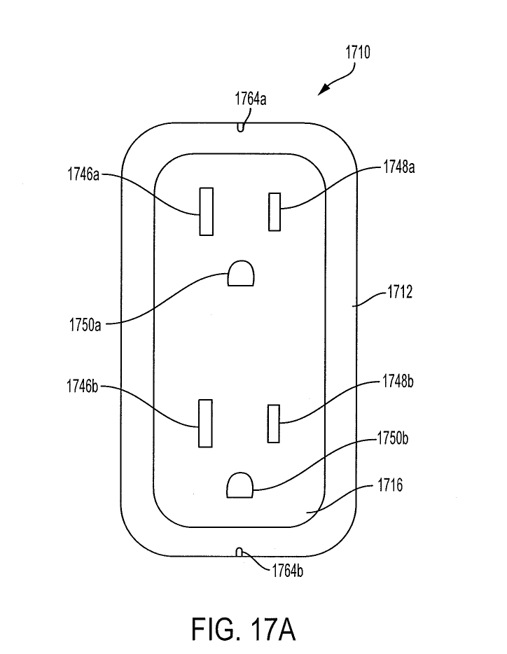

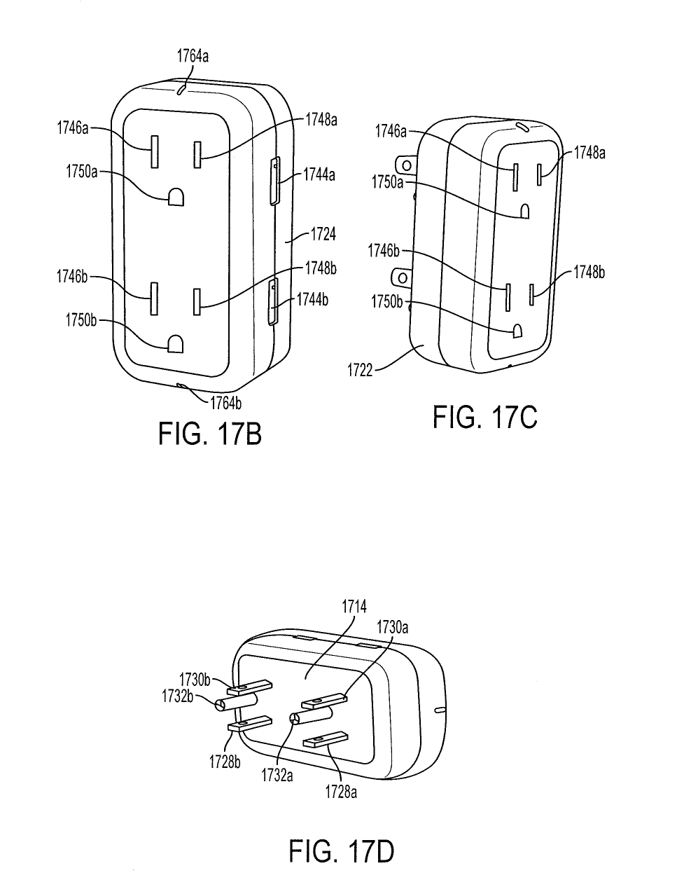

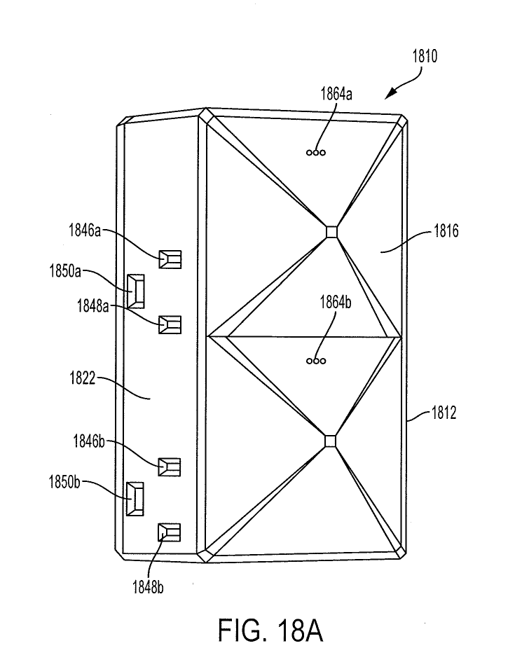

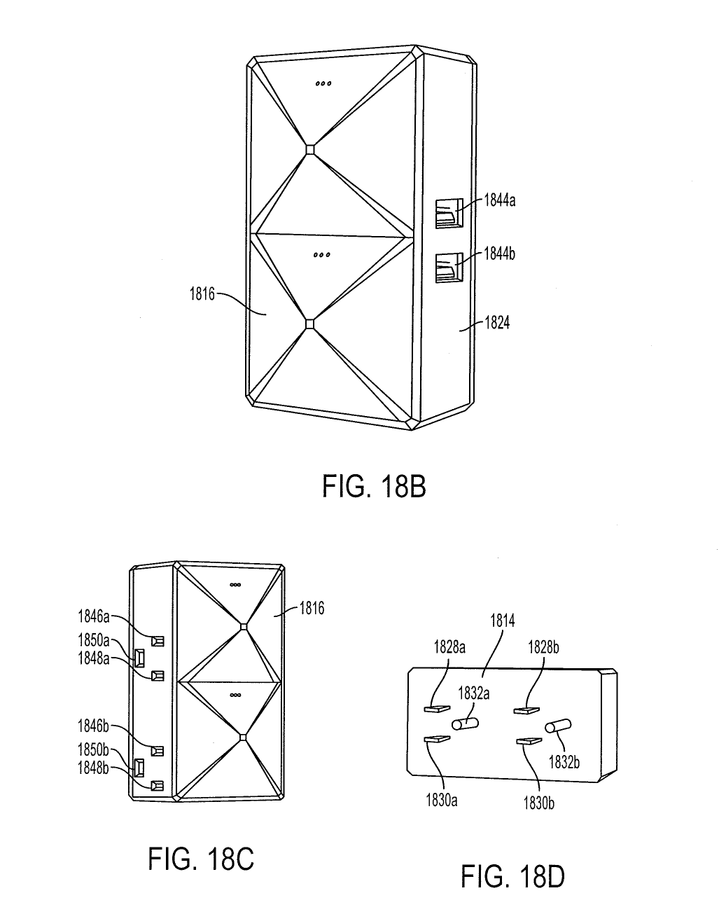

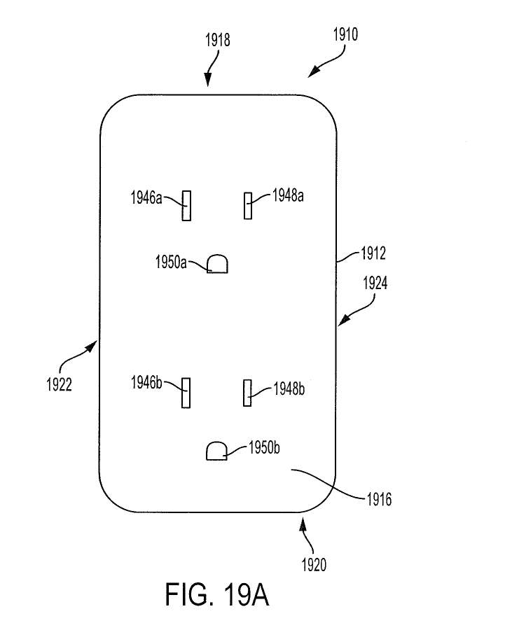

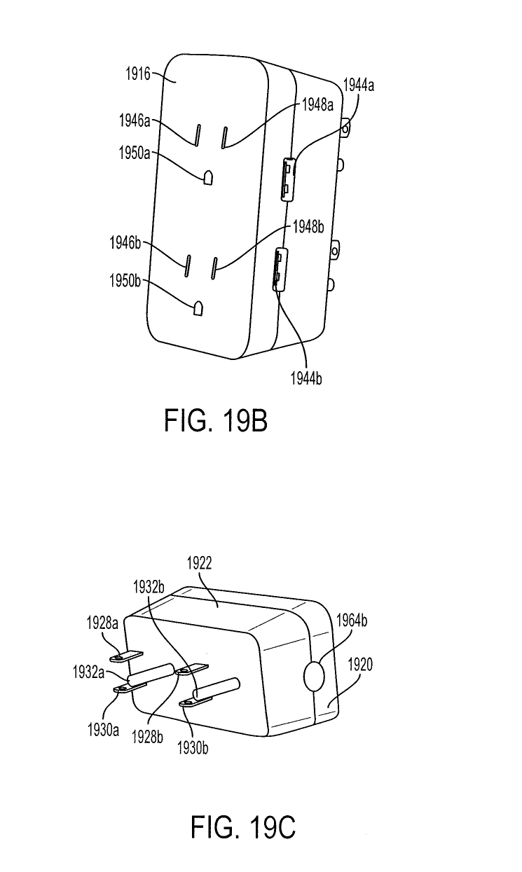

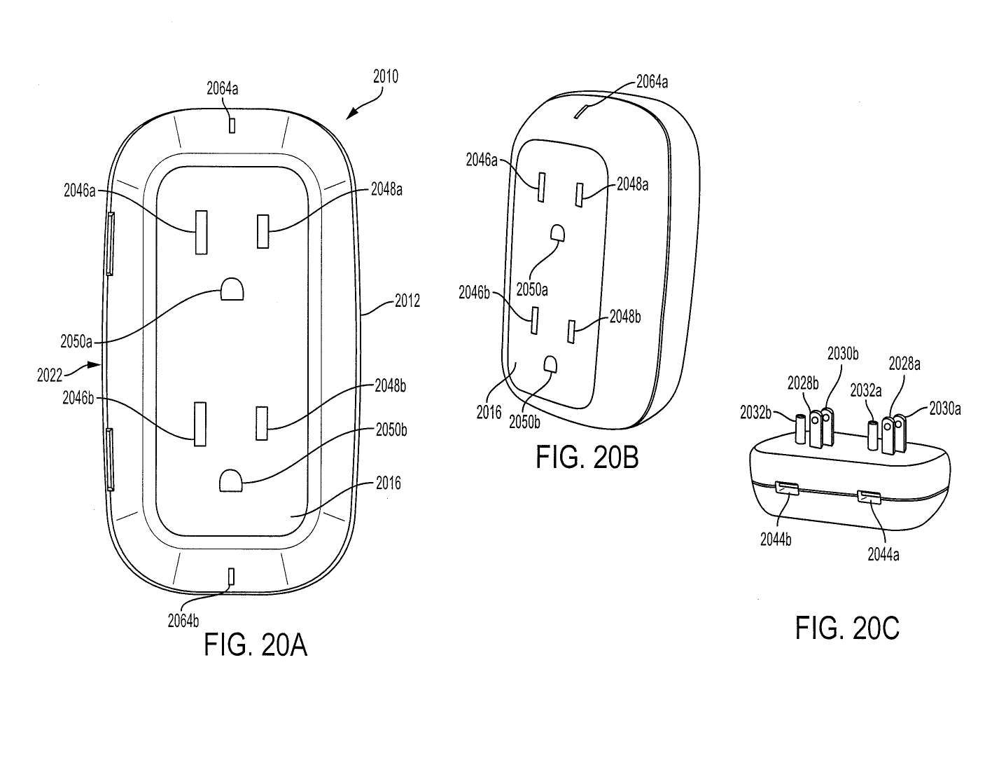

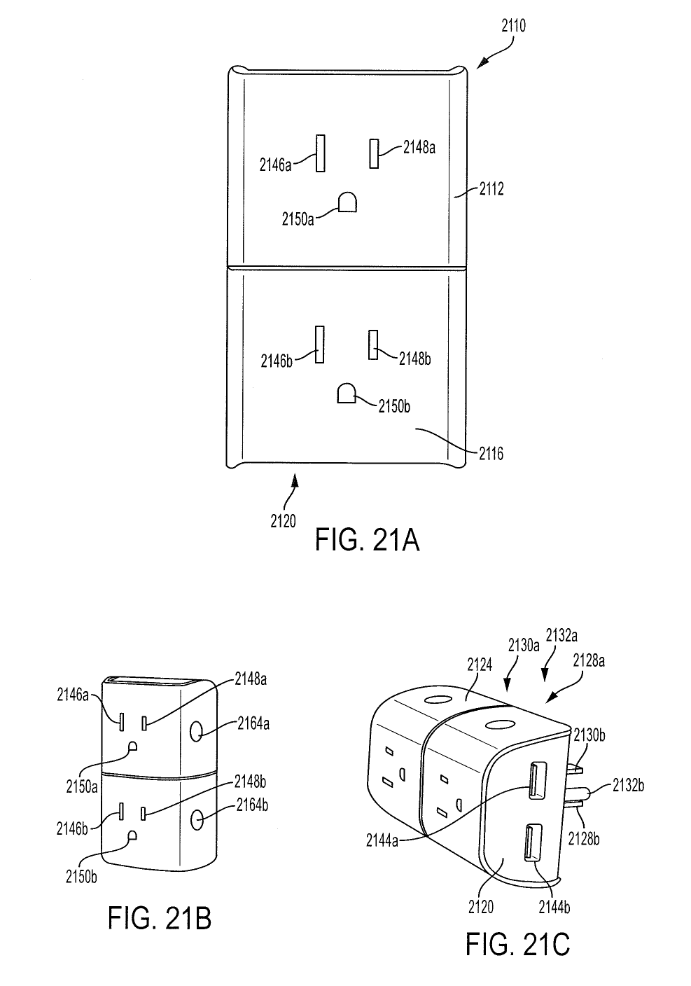

FIGS. 10A-10C illustrate an embodiment of a power charger device 1010. The body 1012 has a substantially cuboid shape. The front face 1016 has a substantially pyramidal shape.

The power prong receptacles 1046, 1048, 1050 are positioned on the left side face 1022 of the body 1012. The power prong receptacles 1046, 1048, 1050 extend on an axes that are transverse, substantially perpendicular to the axes of the power prongs 1028, 1030, 1032.

The data transfer plug receptacle 1044 is positioned on the right side face 1024 of the body 1012. The data transfer plug receptacle 1044 extends on an axis transverse, substantially perpendicular to the axes of the power prongs 1028, 1030, 1032. The data transfer plug receptacle 1044 extends on an axis substantially parallel to the axes of the power prong receptacles 1046, 1048, 1050.

The power indicator 1064 is positioned on the front face 1016 of the body 1012.

FIGS. 11A-11C illustrate an embodiment of a power charger device 1110. The body 1112 has a substantially cuboid shape. The side faces 1118, 1120, 1122, 1124 are angled relative to the front face 1116 to allow a user to more easily grip the power charger device 1110.

The power prong receptacles 1146, 1148, 1150 are positioned on the front face 1116 of the body 1112. The power prong receptacles 1146, 1148, 1150 extend on axes that are substantially parallel to the axes that the prongs 1128, 1130, 1132 extend on, and are offset from the axes that the prongs 1128, 1130, 1132 extend on.

The data transfer plug receptacle 1144 is positioned on the right side face 1124 of the body 1112. The data transfer plug receptacle 1144 extends on an axis transverse, substantially perpendicular to the axes of the power prongs 1128, 1130, 1132 and the power prong receptacles 1146, 1148, 1150. The power indicator 1164 is positioned on a side face 1118 of the body 1112.

FIGS. 12A-12D illustrate an embodiment of a power charger device 1210. The body 1212 has a substantially cuboid shape. The side faces 1218, 1220, 1222, 1224 include portions that are curved and portions that are offset from other portions of the side faces 1218, 1220, 1222, 1224, to allow a user to more easily grip the power charger device 1210.

The power prong receptacles 1246, 1248, 1250 are positioned on the front face 1216 of the body 1212. The power prong receptacles 1246, 1248, 1250 extend on axes that are substantially parallel to the axes that the prongs 1228, 1230, 1232 extend on.

The data transfer plug receptacle 1244 is positioned on the bottom face 1220 of the body 1212. The data transfer plug receptacle 1244 extends on an axis transverse, substantially perpendicular to the axes of the power prongs 1228, 1230, 1232 and the power prong receptacles 1246, 1248, 1250. The power indicator 1264 is positioned on a side face 1218 of the body 1212.

FIGS. 13A-13C illustrate an embodiment of a power charger device 1310. The body 1312 has a substantially cuboid shape. The side faces 1318, 1320 are curved.

The power prong receptacles 1346, 1348, 1350 are positioned on the front face 1316 of the body 1312. The power prong receptacles 1346, 1348, 1350 extend on axes that are substantially parallel to the axes that the prongs 1328, 1330 extend on.

The data transfer plug receptacle 1344 is positioned on the right side face 1324 of the body 1312. The data transfer plug receptacle 1344 extends on an axis transverse, substantially perpendicular to the axes of the power prongs 1328, 1330 and the power prong receptacles 1346, 1348, 1350. The power indicator 1364 is positioned on a side face 1318 of the body 1312.

FIGS. 14A-14D illustrate an embodiment of a power charger device 1410. The power charger device 1410 includes a first power prong set 1426a and a second power prong set 1426b extending from the rear face 1414 of the body 1412. The first power prong set 1426a may include prongs 1428a, 1430a, 1432a and the second power prong set 1426b may include prongs 1428b, 1430b, 1432b. The first power prong set 1426a is positioned at a distance from the second power prong set 1426b. The centerline of each prong 1428a, 1430a, 1432a may be positioned from the centerline of the respective prong 1128b, 1130b, 1132b of the second prong set 1426b at a distance that may be between about 3.5 and 4.5 cm, and may be about 4 cm. The distance between the prongs of the first power prong set 1426a and the second power prong set 1426b may set in accordance with standard size set for dual power sockets such as two power socket wall sockets, for example a NEMA standard as used in North America, among other standards. In one embodiment, the distance may be varied as desired. In one embodiment, the prongs of the first power prong set 1426a and the second power prong set 1426b may be aligned along the height 1447 of the power charger device 1410 to allow both prong sets 1426a, 1426b to be inserted in a two power socket wall socket simultaneously.

The prongs 1428a, 1430a, 1432a of the first power prong set 1426a may extend from the rear face 1414 of the body 1412 on axes that are substantially parallel to any of the axes of the prongs 1428b, 1430b, 1432b of the second power prong set 1426b. The power charger device 1410 includes a first power prong receptacle set 1442a and a second power prong receptacle set 1442b. The first power prong receptacle set 1442a may include power prong receptacles 1446a, 1448a, 1450a and the second power prong receptacle set 1442b may include power prong receptacles 1446b, 1448b, 1450b. The first power prong receptacle set 1442a is positioned at a distance from the second power prong receptacle set 1442b. The centerline of each power prong receptacle 1446a, 1448a, 1450a may be positioned from the centerline of the respective prong receptacle 1446b, 1448b, 1450b at a distance that may be between about 3.5 and 4.5 cm, and may be about 4 cm. In one embodiment, the distance may be varied as desired. In one embodiment, the receptacles of the first power prong receptacle set 1442a and the second power prong receptacle set 1442b may be aligned along the height 1447 of the power charger device 1410 as indicated by lines 1449, 1451, and 1453.

The power prong receptacles 1446a, 1448a, 1450a of the first power prong receptacle set 1442a may extend on axes that are substantially parallel to any of the axes of the power prong receptacles 1446b, 1448b, 1450b of the second power prong receptacle set 1442b. In one embodiment, the power prong receptacles 1446a, 1448a, 1450a of the first power prong receptacle set 1442a may extend on axes that are substantially transverse, including substantially perpendicular, to any of the axes of the power prong receptacles 1446b, 1448b, 1450b of the second power prong receptacle set 1442b.

The power prong receptacles 1446a, 1448a, 1450a of the first power prong receptacle set 1442a may extend on axes that are substantially parallel to any of the axes of the power prong receptacles 1446b, 1448b, 1450b of the second power prong receptacle set 1442b. In one embodiment, the power prong receptacles 1446a, 1448a, 1450a of the first power prong receptacle set 1442a may extend on axes that are substantially transverse, including substantially perpendicular, to any of the axes of the power prong receptacles 1446b, 1448b, 1450b of the second power prong receptacle set 1442b.

Any of the power prong receptacles of the first power prong receptacle set 1442a and/or the second power prong receptacle set 1442b may extend on axes that are substantially parallel to any of the axes of the power prongs of the first power prong set 1426a and/or the second power prong receptacle set 1442b. In one embodiment, any of the power prong receptacles of the first power prong receptacle set 1442a and/or the second power prong receptacle set 1442b may extend on axes that are substantially transverse, including substantially perpendicular, to any of the axes of the power prongs of the first power prong set 1426a and/or the second power prong receptacle set 1426b.

In one embodiment, any of the power prong receptacles of the first power prong receptacle set 1442a and/or the second power prong receptacle set 1442b may extend on axes that are substantially similar as any of the axes of the power prongs of the first power prong set 1426a and/or the second power prong receptacle set 1442b. In one embodiment, the power prong receptacles of the first power prong receptacle set 1442a may extend on axes that are substantially similar as any of the axes of the first power prong set 1426a, and the power prong receptacles of the second power prong receptacle set 1442b may extend on axes that are substantially similar as any of the axes of the second power prong set 1426b.

In one embodiment, any of the axes that the first power prong set 1426a extend on may pass through any of the power prong receptacles 1446a, 1448a, 1450a, including the respective openings of the receptacles 1446a, 1448a, 1450a. In one embodiment, any of the axes that the first power prong set 1426a extend on may pass through an area in between the power prong receptacles 1446a, 1448a, 1450a in a manner similar as shown in FIG. 4, and/or an area extending outward from any of the power prong receptacles 1446a, 1448a, 1450a no more than about 45%, or no more than about 60%, of the distance between the power prong receptacles 1146a, 1148a in a manner similar as shown in FIG. 4.

The power charger device 1410 includes a first data transfer plug receptacle 1444a and a second data transfer plug receptacle 1444b. The first data transfer plug receptacle 1444a is positioned at a distance from the second data transfer plug receptacle 1444b. In one embodiment, the first data transfer plug receptacle 1444a may be positioned from the second data transfer plug receptacle 1444b at a distance that may be between about 3.5 and 4.5 cm, and may be about 4 cm. In one embodiment, the distance may be varied as desired.

The first data transfer plug receptacle 1444a may extend on an axis that is substantially parallel to an axis that the second data transfer plug receptacle 1444b extends on. In one embodiment, the first data transfer plug receptacle 1444a may extend on an axis that is substantially transverse, including substantially perpendicular, to an axis that the second data transfer plug receptacle 1444b extends on.

The first data transfer plug receptacle 1444a and/or the second data transfer plug receptacle 1444b may extend on an axis, or axes as appropriate, that are substantially parallel to any of the axes of the power prongs of the first power prong set 1426a and/or the second power prong receptacle set 1442b. In one embodiment, the first data transfer plug receptacle 1444a and/or the second data transfer plug receptacle 1444b may extend on an axis, or axes as appropriate, that are substantially transverse, including substantially perpendicular, to any of the axes of the power prongs of the first power prong set 1426a and/or the second power prong receptacle set 1442b.

Similar to the embodiment shown in FIG. 3, the cross section of the body 1412 in a plane perpendicular to one of the axes that the prongs 1428a, 1430a, 1432a extend on may have its greatest extent as a function of the distance between the centerlines of the prongs 1428a, 1430a. The cross section of the body 1412 may have its greatest radial distance from the prong 1428a for example of no more than about 5 times the centerline distance between the prongs 1428a and 1430a. In one embodiment, the cross section of the body 1412 may have its greatest radial distance from the prong 1428a for example of no more than about 5.5 times the centerline distance between the prongs 1428a and 1430a. In one embodiment, the cross section of the body 1412 may have its greatest radial distance from the prong 1428a for example of no more than about 6 times the centerline distance between the prongs 1428a and 1430a. This may serve to conform the body 1112 to the size of a two power socket wall socket, without interfering with additional nearby structures. In other embodiments, other greatest radial distances 141 may be utilized.

In one embodiment, the body 1412 may have its greatest cross section in a plane perpendicular to one of the axes that the prongs 1428a, 1430a, 1432a extend on be no more than about 38 square centimeters. In one embodiment, the body 1412 may have its greatest cross section in a plane perpendicular to one of the axes that the prongs 1428a, 1430a, 1432a extend on be no more than about 45 square centimeters. In one embodiment, the body 1412 may have its greatest cross section in a plane perpendicular to one of the axes that the prongs 1428a, 1430a, 1432a extend on be no more than about 50 square centimeters. In one embodiment, the body 1412 may have its greatest cross section in a plane perpendicular to one of the axes that the prongs 1428a, 1430a, 1432a extend on be no more than about 55 square centimeters.

The body 1412 may have a greatest length 1443, width 1445, and height 1447. In one embodiment, the length 1443 may be set to no more than about 3 cm; in one embodiment, the length 1443 may be set to no more than about 3.5 cm; and in one embodiment, the length 1443 may be set to no more than about 4 cm. The length of the body 1412 may be set to reduce the total profile of the body 1412. The length of the body 1412 may also be sized to allow a user to easily grip and insert or remove the power charger device 1410 from a power socket. The dimensions may be set in accordance with the NEMA standard as used in North America.

In one embodiment, the width 1445 may be set to no more than about 2.8 cm; in one embodiment, the width 1445 may be set to no more than about 3 cm; in one embodiment, the width 1445 may be set to no more than about 3.5 cm; in one embodiment, the width 1445 may be set to no more than about 4 cm; in one embodiment, the width 1445 may be set to no more than about 4.5 cm; in one embodiment, the width 1445 may be set to no more than about 5.5 cm; and in one embodiment, the width 1445 may be set to no more than about 6.5 cm. In one embodiment, the height 1447 may be set to no more than about 2.8 cm; in one embodiment, the height 1447 may be set to no more than about 8 cm; in one embodiment, the height 1447 may be set to no more than about 8.5 cm; in one embodiment, the height 1447 may be set to no more than about 9 cm; in one embodiment, the height 1447 may be set to no more than about 9.5 cm; and in one embodiment, the height 1447 may be set to no more than about 10 cm. In other embodiments, other greatest lengths 1443, widths 1445, and heights 1447 may be utilized.

In one embodiment, the body 1412 may have a total volume of no more than about 100 cubic centimeters; in one embodiment, the body 1412 may have a total volume of no more than about 150 cubic centimeters; in one embodiment, the body 1412 may have a total volume of no more than about 200 cubic centimeters; and in one embodiment, the body 1412 may have a total volume of no more than about 250 cubic centimeters. In one embodiment, the body 1412 may have a total volume that is a multiple of any combination of the greatest lengths 1443, widths 1445, and heights 1447 disclosed in this application. In one embodiment, another total volume for the body 1412 may be utilized. The total volume may be configured to allow for access to the receptacles of the body 1412, yet provide a compact size to reduce interference with nearby structures of the power socket.

The power charger device 1410 may utilize the electrical circuits disclosed in regard to FIGS. 6, 6A, 6B, to provide power to the power receptacle sets 1442a, 1442b and the data transfer plug receptacles 1444a, 1444b. The two power receptacle sets 142a, 142b shown schematically in FIGS. 6, 6A, 6B, may correspond to the sets 1442a, 1442b. Either a single power prong set 1426a may correspond to the power input 169 in the manner shown in FIGS. 6, 6A, 6B, or multiple power prong sets 1426a, 1426b may operate in parallel to provide power to respective receptacle sets 1442a, 1442b. An additional data transfer plug receptacle 1444b may be utilized in the schematic of FIGS. 6, 6A, 6B, in the manner discussed in FIGS. 6, 6A, 6B with regard to multiple data transfer plug receptacles 1444a, 1444b.

The power charger device 1410 may utilize power indicators 1464a, 1464b, which may correspond to the power indicators 164b, 164c shown in FIG. 6B, or may correspond to other power indicators disclosed in this application.

In the embodiment shown in FIGS. 14A-14D, the body 1412 has a substantially cuboid shape. The side faces 1418, 1420, 1422, 1424 are contoured to allow a user to more easily grip the body 1412.

The power prong receptacles 1446, 1448, 1450 are positioned on the front face 1416 of the body 1412. The power prong receptacles 1446, 1448, 1450 extend on axes that are substantially parallel to the axes that the prongs 1428, 1430, 1432 extend on.

The data transfer plug receptacles 1444 are positioned on the left side face 1422 of the body 1412. The data transfer plug receptacles 1444 extend on an axis transverse, substantially perpendicular to the axes of the power prongs 1428, 1430, 1432 and the power prong receptacles 1446, 1448, 1450.

The orientation of the power prong receptacles 1446, 1448, 1450 are rotated ninety degrees to the right of the orientation of the power prongs 1428, 1430, 1432. In other embodiment, a different degree of rotation may be utilized.

FIGS. 15A-15C illustrate an embodiment of a power charger device 1510. The body 1512 has a substantially cuboid shape.

The power prong receptacles 1546, 1548, 1550 are positioned on the front face 1516 of the body 1512. The power prong receptacles 1546, 1548, 1550 extend on axes that are substantially parallel to the axes that the prongs 1528, 1530, 1532 extend on.

The data transfer plug receptacles 1544 are positioned on the right side face 1524 of the body 1512. The data transfer plug receptacles 1544 extend on an axis transverse, substantially perpendicular to the axes of the power prongs 1528, 1530, 1532 and the power prong receptacles 1546, 1548, 1550. Power indicators 1564a, 1564b, may be positioned at edges of the body 1512.

FIGS. 16A-16C illustrate an embodiment of a power charger device 1610. The body 1612 has a substantially cuboid shape.

The power prong receptacles 1646, 1648, 1650 are positioned on the front face 1616 of the body 1612. The power prong receptacles 1646, 1648, 1650 extend on axes that are substantially parallel to the axes that the prongs 1628, 1630 extend on.

The data transfer plug receptacles 1644 are positioned on the right side face 1624 of the body 1612. The data transfer plug receptacles 1644 extend on an axis transverse, substantially perpendicular to the axes of the power prongs 1628, 1630 and the power prong receptacles 1646, 1648, 1650. Power indicators 1664a, 1664b, may be positioned at corners of the body 1612.

FIGS. 17A-17D illustrate an embodiment of a power charger device 1710. The body 1712 has a substantially cuboid shape.

The power prong receptacles 1746, 1748, 1750 are positioned on the front face 1716 of the body 1712. The power prong receptacles 1746, 1748, 1750 extend on axes that are substantially parallel to the axes that the prongs 1728, 1730, 1732 extend on. The prongs 1728, 1730, 1732 extend from a rear face 1714 of the body 1712.

The data transfer plug receptacles 1744 are positioned on the right side face 1724 of the body 1712. The data transfer plug receptacles 1744 extend on an axis transverse, substantially perpendicular to the axes of the power prongs 1728, 1730, 1732 and the power prong receptacles 1746, 1748, 1750. Power indicators 1764a, 1764b, may be positioned at edges of the body 1712.

FIGS. 18A-18D illustrate an embodiment of a power charger device 1810. The body 1812 has a substantially cuboid shape. The front face 1816 has a substantially pyramidal shape.

The power prong receptacles 1846, 1848, 1850 are positioned on the left side face 1822 of the body 1512. The power prong receptacles 1846, 1848, 1850 extend on axes that are transverse and substantially perpendicular to the axes that the prongs 1828, 1830, 1832 extend on.

The data transfer plug receptacles 1844 are positioned on the right side face 1824 of the body 1812. The data transfer plug receptacles 1844 extend on an axis transverse, substantially perpendicular to the axes of the power prongs 1828, 1830, 1832. The data transfer plug receptacles 1844 extend on an axis substantially parallel to the axes of the power prong receptacles 1846, 1848, 1850. Power indicators 1864a, 1864b, may be positioned on the front face 1816 of the body 1812.

FIGS. 19A-19C illustrate an embodiment of a power charger device 1910. The body 1912 has a substantially cuboid shape. The side faces 1918, 1920, 1922, 1924 are angled relative to the front face 1916 to allow a user to more easily grip the power charger device 1910.

The power prong receptacles 1946, 1948, 1950 are positioned on the front face 1916 of the body 1912. The power prong receptacles 1946, 1948, 1950 extend on axes that are substantially parallel to the axes that the prongs 1928, 1930, 1932 extend on.

The data transfer plug receptacles 1944 are positioned on the right side face 1924 of the body 1912. The data transfer plug receptacles 1944 extend on an axis transverse, substantially perpendicular to the axes of the power prongs 1928, 1930, 1932 and the power prong receptacles 1946, 1948, 1950. A power indicator 1964b may be positioned on a side face 1920 of the body 1912.

FIGS. 20A-20C illustrate an embodiment of a power charger device 2010. The body 2012 has a substantially cuboid shape.

The power prong receptacles 2046, 2048, 2050 are positioned on the front face 2016 of the body 2012. The power prong receptacles 2046, 2048, 2050 extend on axes that are substantially parallel to the axes that the prongs 2028, 2030, 2032 extend on.

The data transfer plug receptacles 2044 are positioned on the left side face 2022 of the body 2012. The data transfer plug receptacles 2044 extend on an axis transverse, substantially perpendicular to the axes of the power prongs 2028, 2030, 2032 and the power prong receptacles 2046, 2048, 2050. Power indicators 2064a, 2064b, may be positioned at edges of the body 2012.

FIGS. 21A-21C illustrate an embodiment of a power charger device 2110. The body 2112 has a substantially cuboid shape.

The power prong receptacles 2146, 2148, 2150 are positioned on the front face 2116 of the body 2112. The power prong receptacles 2146, 2148, 2150 extend on axes that are substantially parallel to the axes that the prongs 2128, 2130, 2132 extend on.

The data transfer plug receptacles 2144 are positioned on the bottom face 2120 of the body 2112. The data transfer plug receptacles 2144 extend on an axis transverse, substantially perpendicular to the axes of the power prongs 2128, 2130, 2132 and the power prong receptacles 2146, 2148, 2150. Power indicators 2164a, 2164b, may be positioned on a side face 2124 of the body 2112.

The embodiments of the power charger device disclosed in this application beneficially allow for insertion into a wall socket or other power socket such as in a power strip, while reducing the interference of the power charger device with structures surrounding the power socket. A user may beneficially use the data transfer plug receptacle to power a mobile device, yet may still have access to power prong receptacles, to allow the user to power other devices. The orientation of the power prong receptacles and the data transfer plug receptacles disclosed herein beneficially allows for ease of access to both forms of receptacles, and also maintains a compact size for the power charger device.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of systems, apparatuses, and methods as disclosed herein, which is defined solely by the claims. Accordingly, the systems, apparatuses, and methods are not limited to that precisely as shown and described.

Certain embodiments of systems, apparatuses, and methods are described herein, including the best mode known to the inventors for carrying out the same. Of course, variations on these described embodiments will become apparent to those of ordinary skill in the art upon reading the foregoing description. The inventor expects skilled artisans to employ such variations as appropriate, and the inventors intend for the systems, apparatuses, and methods to be practiced otherwise than specifically described herein. Accordingly, the systems, apparatuses, and methods include all modifications and equivalents of the subject matter recited in the claims appended hereto as permitted by applicable law. Moreover, any combination of the above-described embodiments in all possible variations thereof is encompassed by the systems, apparatuses, and methods unless otherwise indicated herein or otherwise clearly contradicted by context.

Groupings of alternative embodiments, elements, or steps of the systems, apparatuses, and methods are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses an approximation that may vary. The terms “approximat[e][ly][ion],” and “substantial[ly]” represent an amount that may vary from the stated amount, yet is capable of performing the desired operation or process discussed herein.

The terms “a,” “an,” “the” and similar referents used in the context of describing the systems, apparatuses, and methods (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the systems, apparatuses, and methods and does not pose a limitation on the scope of the systems, apparatuses, and methods otherwise claimed. No language in the present specification should be construed as indicating any non-claimed element essential to the practice of the systems, apparatuses, and methods.

All patents, patent publications, and other publications referenced and identified in the present specification are individually and expressly incorporated herein by reference in their entirety for the purpose of describing and disclosing, for example, the compositions and methodologies described in such publications that might be used in connection with the systems, apparatuses, and methods. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A power charger device comprising:
a charger body having a rear face, a front face facing opposite the rear face, and a plurality of side faces each extending between the rear face and the front face;
at least two power prongs spaced from each other and extending outward from the rear face;
at least two power prong receptacles spaced from each other and positioned on at least one of the front face or one of the plurality of side faces;
a data transfer plug receptacle positioned on at least one of the front face or one of the plurality of side faces; and
a circuit configured to provide power from the at least two power prongs to the at least two power prong receptacles and to the data transfer plug receptacle.

2. The power charger device of claim 1, wherein the data transfer plug receptacle is a Universal Serial Bus plug receptacle.

3. The power charger device of claim 1, wherein the data transfer plug receptacle is positioned on at least one of the front face or one of the plurality of side faces that the at least two power prong receptacles are not positioned on.

4. The power charger device of claim 1, wherein each of the at least two power prongs extends on a respective axis, and the data transfer plug receptacle extends on an axis that is transverse to each of the axes that the at least two power prongs extend on.

5. The power charger device of claim 4, wherein each of the at least two power prong receptacles extends on a respective axis that is substantially parallel to each of the axes that the at least two power prongs extend on.

6. The power charger device of claim 5, wherein each of the axes that the at least two power prongs extend on pass through one of the at least two power prong receptacles.

7. The power charger device of claim 1, wherein each of the at least two power prongs extends on a respective axis, and each of the at least two power prong receptacles extend on a respective axis that are each transverse to each of the axes that the at least two power prongs extend on.

8. The power charger device of claim 1, wherein each of the at least two power prong receptacles extend on a respective axis, and the data transfer plug receptacle extends on an axis that is substantially parallel to each of the axes that the at least two power prongs receptacles extend on.

9. The power charger device of claim 1, wherein the at least two power prong receptacles are positioned on the front face.

10. The power charger device of claim 9, wherein the data transfer plug receptacle is positioned on one of the plurality of side faces.

11. The power charger device of claim 1, wherein the charger body has a maximum cross sectional area of no more than about 8 square centimeters perpendicular to an axis that one of the at least two power prongs extends along.

12. The power charger device of claim 1, wherein the charger body has a volume of no more than about 32 cubic centimeters.

13. The power charger device of claim 1, wherein the at least two power prongs include a live power prong and a neutral prong.

14. The power charger device of claim 13, wherein the at least two power prongs include a grounding power prong.

15. The power charger device of claim 13, wherein the live power prong extends on an axis, and a maximum radial distance of the charger body from the axis is no more than about 2 times a centerline distance of the live power prong from the neutral power prong.

16. The power charger device of claim 13, wherein a centerline distance of the live power prong from the neutral power prong is no more than about 1.3 centimeters.

17. The power charger device of claim 13, wherein a centerline distance of the live power prong from the neutral power prong is between about 1.2 centimeters and 1.4 centimeters.

18. The power charger device of claim 1, wherein an edge joins two of the plurality of side faces.

19. A power charger device comprising:
a charger body having a rear face, a front face facing opposite the rear face, and a plurality of side faces each joining the rear face to the front face;
a first prong set including a first live power prong and a first neutral power prong spaced from each other and extending outward from the rear face and configured to enter a first power socket;
a second prong set including a second live power prong and a second neutral power prong spaced from each other and extending outward from the rear face and configured to enter a second power socket;
a first power prong receptacle set including at least two power prong receptacles spaced from each other and positioned on at least one of the front face or one of the plurality of side faces;
a second power prong receptacle set including at least two power prong receptacles spaced from each other and positioned on at least one of the front face or one of the plurality of side faces;
a data transfer plug receptacle positioned on at least one of the front face or one of the plurality of side faces; and
a circuit configured to provide power from at least one of the first prong set or the second prong set to the data transfer plug receptacle and the first power prong receptacle set and the second power prong receptacle set.

20. The power charger device of claim 19, wherein the data transfer plug receptacle is positioned on at least one of the front face or one of the plurality of side faces that the first power prong receptacle set or the second power prong receptacle set is not positioned on.
